(19) United States
(12) Patent Application Publication
(10) Pub. No.: US 2018/0266344 A1
(43) Pub. Date: Sep. 20, 2018

(54) INTERNAL COMBUSTION ENGINE

(71) Applicant: KABUSHIKI KAISHA TOYOTA CHUO KENKYUSHO, Nagakute-shi (JP)

(72) Inventors: Ryuta MORIYASU, Nagakute-shi (JP); Kazuhisa INAGAKI, Nagakute-shi (JP); Matsuei UEDA, Nagakute-shi (JP); Makoto NAGAOKA, Nagakute-shi (JP); Taro IKEDA, Nagakute-shi (JP)

(73) Assignee: KABUSHIKI KAISHA TOYOTA CHUO KENKYUSHO, Nagakute-shi (JP)

(21) Appl. No.: 15/921,960

(22) Filed: Mar. 15, 2018

(30) Foreign Application Priority Data
Mar. 16, 2017 (JP) 2017-050814
Dec. 27, 2017 (JP) 2017-250479
Jan. 29, 2018 (JP) 2018-012813

(51) Int. Cl. F02D 41/00; F01N 3/10; F01N 3/20; F01N 13/00; F02D 41/10

(52) U.S. Cl. CPC F02D 41/0057; F01N 3/101; F01N 3/208; F02D 41/0097; F02D 41/10; F01N 2560/06; F01N 13/009

(57) ABSTRACT

An internal combustion engine is provided, in which a quantity of NOx emission can be reduced without using any special components even when a NOx reduction catalyst has an elevated temperature due to high-load operation. The internal combustion engine includes an engine, a three-way catalyst and a NOx reduction catalyst for purifying exhaust gas emitted from the engine, a temperature sensor for acquiring the temperature of the NOx reduction catalyst, a rotation speed sensor for acquiring an engine rotation speed, an injection controller for controlling a fuel injection quantity in the engine, and a combustion switching controller for switching a combustion mode of the engine between lean and stoichiometric combustion modes based on the NOx reduction catalyst temperature, the engine rotation speed, and the fuel injection quantity acquired from the fuel injection controller.

### CROSS REFERENCE TO RELATED APPLICATION

The disclosures of Japanese Patent Application Nos. 2017-050814 filed on Mar. 16, 2017, 2017-250479 filed on Dec. 27, 2017, and 2018-012813 filed on Jan. 29, 2018, including specifications, claims, drawings and abstracts, are incorporated herein by reference in their entireties.

### TECHNICAL FIELD

The present invention relates to an internal combustion engine, and more particularly, to an internal combustion engine including, as exhaust gas purification catalysts, a three-way catalyst and a NOx reduction catalyst.

### BACKGROUND

In the related art, JP 2012-197794 A discloses a compression-ignition engine equipped with a three-way catalytic converter to reduce harmful exhaust gases. In the compression-ignition engine, in a first mode, at low engine loads, the engine is operated at a high exhaust gas recirculation (EGR) rate in a normal diesel combustion state to reduce NOx emissions; in a second mode, at medium to high engine loads, the engine is operated in a stoichiometric state where NOx emissions can be reduced by means of the three-way catalytic converter; and, in a third mode, at very high engine loads and/or engine speeds, the engine is operated in a normal diesel combustion state at a low EGR rate to obtain a maximum torque.

On the other hand, JP 2004-285832 A discloses a diesel engine including a three-way catalyst, an HC trap catalyst, and a NOx trap (NSR) catalyst which are successively arranged in an exhaust gas passage to reduce HC and NOx in cold time, and further including temperature sensors for the HC trap catalyst and the NOx trap catalyst, and an exhaust air-fuel ratio sensor. In the diesel engine, after cold start, rich operation in which an exhaust air-fuel ratio is set to be rich is initially performed with the intention of reducing NOx and causing swift activation of the catalysts. In the rich operation, HC is trapped by the HC trap catalyst. Then, the rich operation is finished when the temperature of the HC trap catalyst reaches a catalyst temperature at which HC can be desorbed from the HC trap catalyst and purified. JP 2004-285832 A further describes that when the NOx trap catalyst does not reach a temperature at which it can trap NOx, stoichiometric operation is performed, and after the NOx trap catalyst reaches that temperature, the stoichiometric operation is changed to lean operation for facilitating desorption and purification of NOx.

Meanwhile, JP 2011-220214 A discloses a fuel injection controlling apparatus that, in an internal combustion engine equipped with an exhaust gas purification catalyst, prevents the catalyst from being deteriorated in purification capability due to excessive heat applied to the catalyst from high-temperature exhaust gases. In the fuel injection controlling apparatus, the temperature of the catalyst is calculated based on operation states of the internal combustion engine, and when the calculated result exceeds a predetermined temperature, an injection quantity of fuel is increased to lower the temperature of exhaust gas using heat of fuel vaporization, and accordingly cool the catalyst.

In addition, JP 5866833 B discloses an internal combustion engine in which the emission of NOx is suppressed by controlling an EGR rate in consideration of, in addition to a rotation speed and a load of the internal combustion engine, the temperature of a catalyst. In the internal combustion engine, when a NOx catalyst is excessively heated, resulting in deteriorated NOx purification performance, generation of NOx is curbed through in-cylinder combustion in the internal combustion engine. That is, under the above-described conditions, a quantity of EGR gas is increased to lower a combustion temperature and accordingly curb the generation of NOx. In this operation, because an increase in temperature of the catalyst is simultaneously minimized due to a decreased temperature of the exhaust gases, recovery of purification properties of the NOx catalyst is facilitated.

On the other hand, JP 2010-168942 A discloses that, in an internal combustion engine including an exhaust gas purification catalyst, an exhaust gas return passage, and an EGR cooler, the EGR cooler is controlled to lower the temperature of returned exhaust gas in the exhaust gas return passage.

### CITATION LIST

### Patent Literature

[Patent Document 1] JP 2012-197794 A

[Patent Document 2] JP 2004-285832 A

[Patent Document 3] JP 2011-220214 A

[Patent Document 4] JP 5866833 B

[Patent Document 5] JP 2010-168942 A

### SUMMARY

### Technical Problem

In the above-described technique of JP 2012-197794 A, while an expensive NOx reduction catalyst is eliminated, NOx is purified by means of stoichiometric combustion and the three-way catalyst. However, because normal lean combustion is performed in the third mode at high engine loads, the technique has a problem in that the quantity of NOx emissions is increased during the lean combustion.

Meanwhile, in the above-described technique of JP 2004-285832 A, because the NOx trap catalyst is not activated in cold time, NOx is purified through the three-way catalyst by performing stoichiometric combustion during the cold time. Then, after the NOx trap catalyst is increased in temperature to a certain level, because the NOx trap catalyst is activated to occlude NOx, lean combustion is performed to occlude/reduce NOx through the NOx trap catalyst. In this technique, however, no consideration is given to a phenomenon in which the NOx purification performance of the NOx trap catalyst is deteriorated when the NOx trap catalyst is increased in temperature by operation of the diesel engine at high loads, resulting in an increased quantity of NOx emissions.

On the other hand, in the above-described technique of JP 2011-220214 A in which the injection quantity of fuel is increased to use the heat of fuel vaporization for cooling the catalyst, the fuel is additionally injected, which raises a problem of poor fuel efficiency. Meanwhile, in the above-described technique of JP 5866833 B, the generation itself of NOx resulting from combustion in the internal combustion engine is curbed by increasing the quantity of EGR gas, and the emission of NOx is also reduced through the cooling of the catalyst due to the decreased temperature of the exhaust gas. However, in this technique, there is a physical upper limit to an introducible quantity of EGR gas established by a pressure difference of the EGR gas between an intake side and an exhaust side. In particular, in a case of high-pressure loop EGR in which the exhaust gas is returned from a portion of an exhaust system close to an exhaust port of the engine to a portion of an intake system close to an intake port of the engine, an increasable quantity of the EGR gas is further limited under conditions of high-load operation where the catalyst temperature is easily increased. As opposed to this, in a case of low-pressure loop EGR in which the exhaust gas is returned from a portion of the exhaust system distant from the exhaust port of the engine to a portion of the intake system distant from the intake port of the engine, it is possible to raise the upper limit to the introducible quantity of EGR gas, which presents a problem of poor response resulting from an extended length of a return passage.

In the technique disclosed in JP 2010-168942 A, a degree of reactivity of the catalyst is detected, and when the detected degree of reactivity is low, the temperature of the returned exhaust gas (EGR temperature) is lowered to reduce NOx generated through combustion in the internal combustion engine. However, the lowering of the EGR temperature results in a lowered temperature of exhaust gas, which may raise a problem in that the timing at which the catalyst becomes active may be delayed. In addition, during operation under a high-load condition accompanied with an increase in temperature of the exhaust gas, control operation to close a bypass valve for the EGR cooler is performed (i.e., control operation to lower the EGR temperature by means of the EGR cooler). The control operation is based on a rotation speed and a load of the internal combustion engine, without taking into account a state of the catalyst (a catalyst temperature). Therefore, the bypass valve for the EGR cooler may be closed even when the catalyst temperature is low. In this case, the EGR temperature is lowered, which in turn lowers the exhaust gas temperature, resulting in a delay of warming of the exhaust gas purification.

An object of the present invention is to provide an internal combustion engine in which a quantity of NOx emissions can be reduced without using any special components even when a NOx reduction catalyst is increased in temperature due to operation at high loads.

Another object of the present invention is to provide an internal combustion engine whose fuel efficiency can be improved while preventing an increase in the quantity of NOx emissions.

A further object of the present invention is to provide an internal combustion engine in which an increase in temperature of the NOx reduction catalyst can be curbed by lowering the temperature of intake gas and/or recirculated exhaust gas, to thereby lower the temperature of exhaust gas.

### Solution to Problem

An internal combustion engine according to an aspect of the present invention includes an engine, a three-way catalyst and a NOx reduction catalyst that purify exhaust gas emitted from the engine, a temperature acquiring unit that acquires a temperature of the NOx reduction catalyst, a rotation speed acquiring unit that acquires a rotation speed of the engine, an injection controller that controls a fuel injection quantity in the engine, a combustion switching controller that switches a combustion mode of the engine between a lean combustion mode and a stoichiometric combustion mode based on the temperature of the NOx reduction catalyst acquired by the temperature acquiring unit, the rotation speed of the engine acquired by the rotation speed acquiring unit, and the fuel injection quantity acquired from the injection controller.

### Advantageous Effects of Invention

According to the internal combustion engine of this invention, when the temperature of the NOx reduction catalyst detected by a temperature acquiring unit has a high temperature exceeding a predetermined value, the combustion mode of the engine is switched from the lean combustion mode to the stoichiometric combustion mode, which allows the three-way catalyst to perform NOx purification. In this way, even when the temperature of the NOx reduction catalyst is elevated due to high-load operation of the engine, resulting in a deteriorated NOx purification property, the quantity of NOx emissions can be reduced with a high degree of efficiency.

### BRIEF DESCRIPTION OF DRAWINGS

Embodiments of the present disclosure will be described by reference to the following figures, wherein:

FIG. 1 is a diagram schematically showing an overall configuration of an internal combustion engine according to a first embodiment of this invention;

FIG. 2 is a flowchart showing process steps performed in a combustion switching controller of the internal combustion engine illustrated in FIG. 1;

FIG. 3 is a graph showing an example of a map representing EGR rates;

FIG. 4 shows graphs respectively representing (a) the temperature of a NOx reduction (SCR) catalyst, (b) a purification property of the SCR catalyst, (c) a change in an air-fuel ratio caused by switching combustion modes, and (d) NOx purification quantities of a three-way catalyst and the NOx reduction catalyst;

FIG. 5 is a diagram schematically showing an overall configuration of an internal combustion engine according to a second embodiment;

FIG. 6A is a flowchart showing process steps performed in the combustion switching controller of the internal combustion engine illustrated in FIG. 5;

FIG. 6B is a flowchart showing process steps performed subsequent to the process steps of FIG. 6A in the combustion switching controller of the internal combustion engine illustrated in FIG. 5;

FIG. 7 is a graph showing an example of a map on which a lower limit is set to a stoichiometric combustion region;

FIG. 8 shows graphs representing (a) a change in the purification property of the SCR catalyst, and (b) a regulated state of each circulation quantity of exhaust gas through the three-way catalyst and through the SCR catalyst;

FIG. 9 is a diagram schematically showing an overall configuration of an internal combustion engine according to a third embodiment;

FIG. 10 is a flowchart showing process steps performed in the combustion switching controller of the internal combustion engine illustrated in FIG. 9;

FIG. 11 shows graphs respectively representing (a) the temperature of the NOx reduction (SCR) catalyst, (b) the purification property of the SCR catalyst, (c) a change in an air-fuel ratio, (d) the output of an electrically operated supercharger, and (e) a supercharging pressure;

FIG. 12 is a flowchart showing process steps of another processing performed in a combustion switching controller of the internal combustion engine illustrated in FIG. 9;

FIG. 13 shows graphs respectively representing (a) the temperature of the NOx reduction (SCR) catalyst, (b) the supercharging pressure, the EGR rate, and the air-fuel (A/F) ratio, and (c) a quantity of in-cylinder gas;

FIG. 14 is a diagram schematically showing an overall configuration of an internal combustion engine according to a fourth embodiment;

FIG. 15 shows an intercooler illustrated in FIG. 14;

FIG. 16 is a flowchart showing process steps performed in the combustion switching controller of the internal combustion engine illustrated in FIG. 14;

FIG. 17 shows graphs respectively representing (a) the temperature of the NOx reduction (SCR) catalyst, (b) the purification property of the SCR catalyst, (c) the air-fuel ratio, (d) action of an intercooler valve, and (e) an exhaust gas temperature;

FIG. 18 is a diagram schematically showing an overall configuration of an internal combustion engine according to a fifth embodiment;

FIG. 19 shows an EGR cooler illustrated in FIG. 18;

FIG. 20 is a flowchart showing process steps performed in the combustion switching controller of the internal combustion engine illustrated in FIG. 18; and

FIG. 21 shows graphs respectively representing (a) the temperature of the NOx reduction (SCR) catalyst, (b) the purification property of the SCR catalyst, (c) an air-fuel ratio, (d) action of the intercooler valve, (e) action of an EGR cooler valve, and (f) the exhaust gas temperature.

### DESCRIPTION OF EMBODIMENTS

Hereinafter, embodiments according to the present invention will be described in detail with reference to the accompanying drawings. In the following description, specific shapes, materials, numerical values, directions, and other features are provided by way of illustration to facilitate understanding of this invention, and may be appropriately changed depending on uses, purposes, specifications, or other factors. In addition, when multiple embodiments and modification examples are described below, it is originally intended that characteristic features in the embodiments or modification examples may be used in appropriate combinations.

Further, although the embodiments are explained with reference to an example where an engine is a diesel engine of a compression ignition type, the present invention is not limited to the example, and may be applied to an internal combustion engine including a gasoline engine of a spark ignition type.

### First Embodiment

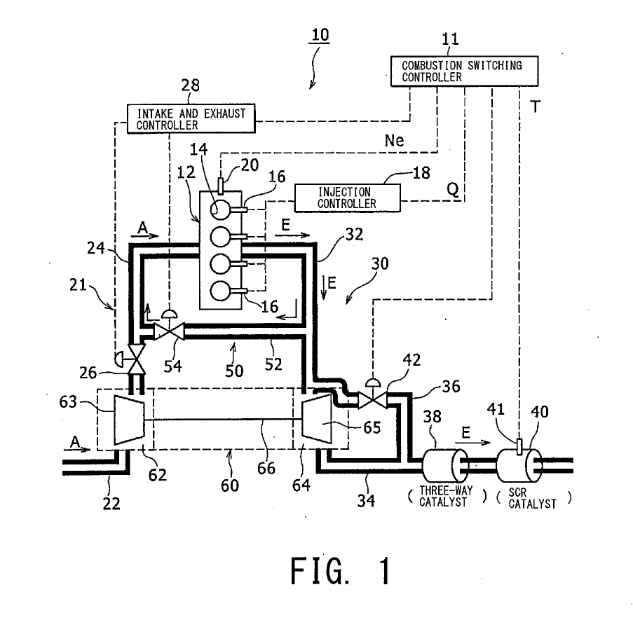

FIG. 1 schematically shows an overall configuration of an internal combustion engine 10 according to a first embodiment of this invention. The internal combustion engine 10 has an engine 12. In this embodiment, the engine 12 is a diesel engine of a compression-ignition type, and includes, for example, four cylinders 14. In each of the cylinders 14, a fuel injection device 16 is installed. Each of fuel injection devices 16 is controlled to adjust a fuel injection quantity and injection timing by an injection controller 18 that has received a signal from a combustion switching controller 11.

In addition, a rotation speed sensor (rotation speed acquiring unit) 20 is installed in the engine 12. The rotation speed sensor 20 has a function of acquiring, as an engine rotation speed Ne, the number of rotations of a crank shaft connected to pistons of the cylinders in the engine 12. The engine rotation speed Ne acquired by the rotation speed sensor 20 is transmitted to the combustion switching controller 11 for use in operations, such as switching of combustion modes, in the engine 12.

The internal combustion engine 10 further includes an intake system 21, an exhaust system 30, an exhaust gas returning device 50, and a turbocharger (supercharger) 60.

The intake system 21 is an air passage to supply air to the engine 12. An intake direction in the intake system 21 is indicated by an arrow A in FIG. 1. The intake system 21 includes a first intake gas passage 22 and a second intake gas passage 24. One end of the first intake gas passage 22 is open to the atmosphere via an unillustrated filter and other components, and the other end is connected to a compressor chamber 62 in the turbocharger 60. One end of the second intake gas passage 24 is connected to the compressor chamber 62, and the other end is connected to an intake port of the engine 12. The second intake gas passage 24 is equipped with an intake throttle valve 26. The intake throttle valve 26 is preferably composed of, for example, a solenoid valve. In the present embodiment, the intake throttle valve 26 is placed in the vicinity of the compressor chamber 62 of the turbocharger 60.

The intake throttle valve 26 is an air volume regulating device for regulating a quantity of air introduced into the engine 12. An opening of the intake throttle valve 26 is regulated in response to a signal from an intake and exhaust controller 28. The intake and exhaust controller 28 transmits and receives signals to and from the combustion switching controller 11. Upon receipt of a command signal from the combustion switching controller 11, the intake and exhaust controller 28 transmits a signal indicative of the opening to the intake throttle valve 26. Further, the intake and exhaust controller 28 transmits a signal representing a state of the opening of the intake throttle valve 26 to the combustion switching controller 11. It should be noted that the intake throttle valve 26 may constitute a part of a supercharging pressure regulating device for regulating a supercharging pressure established by the turbocharger 60.

The exhaust system 30 is an exhaust gas passage through which the exhaust gas discharged from the engine 12 is released to the outside, and includes a first exhaust gas passage 32, a second exhaust gas passage 34, and a turbine bypass channel 36. One end of the first exhaust gas passage 32 is connected to an exhaust port of the engine 12, and the other end is connected to a turbine chamber 64 in the turbocharger 60. One end of the second exhaust gas passage 34 is connected to the turbine chamber 64, and the other end is open to the atmosphere via an unillustrated muffler (or a silencer).

The second exhaust gas passage 34 is equipped with a three-way catalyst 38 and a NOx reduction catalyst 40. While the exhaust gas is passing through the three-way catalyst 38 and the NOx reduction catalyst 40, HC (hydrocarbon), CO (carbon monoxide), NOx (nitrogen oxide), etc. are eliminated from the exhaust gas, and purified to be released into the atmosphere. Note that, in the present embodiment, catalysts (such as an HC trap catalyst and a particulate filter (DPF)) other than the three-way catalyst 38 and the NOx reduction catalyst 40 are not installed, but may be installed.

The three-way catalyst 38 has a function of eliminating/purifying HC, CO, and NOx contained in the exhaust gas through oxidizing/reducing action. The purification efficiency of the three-way catalyst 38 is enhanced when an air-fuel ratio matches a stoichiometric ratio, and can be maintained at a relatively high level even at elevated temperatures. On the other hand, the NOx reduction catalyst 40 has a function of mainly eliminating/purifying NOx contained in the exhaust gas through reducing action. The purification efficiency of the NOx reduction catalyst 40 is very high even in lean operation, but tends to be lowered slightly at elevated temperatures.

In the present embodiment, a catalyst of a selective catalytic reduction (SCR) catalyst is preferably used as the NOx reduction catalyst 40. However, the NOx reduction catalyst 40 is not limited to the SCR catalyst, and may be composed of a NOx storage and reduction (NSR) catalyst or a combination of the SCR and NSR catalysts. It should be noted that the three-way catalyst and the SCR and NSR catalysts may be implemented using any suitable catalysts which have been publicly known or will be developed in the future.

The NOx reduction catalyst 40 is equipped with a temperature sensor 41. The temperature sensor 41 constitutes a temperature acquiring unit for acquiring a temperature T of the NOx reduction catalyst 40. Preferably, the temperature sensor 41 is disposed so as to detect an internal temperature of the NOx reduction catalyst 40. The temperature T of the NOx reduction catalyst 40 acquired by the temperature sensor 41 is sent to the combustion switching controller 11. Although in the present embodiment an example of detecting the temperature T of the NOx reduction catalyst 40 with the temperature sensor 41 is explained, this invention is not limited to the example, and the temperature T of the NOx reduction catalyst 40 may be predicted by the combustion switching controller 11 based on the temperature of the exhaust gas flowing through the first or second exhaust gas passage 32 or 34.

In the present embodiment, the NOx reduction catalyst 40 is arranged downstream of the three-way catalyst 38 in an exhaust gas discharge direction (a direction of an arrow E). Conversely, the three-way catalyst 38 is positioned upstream of the NOx reduction catalyst 40 in the exhaust gas discharge direction E. Because the three-way catalyst 38 has a superior degree of resistance to elevated temperatures than that of the NOx reduction catalyst 40, and thus maintains its property of purifying contaminants, such as NOx, even at elevated temperatures, it is preferable that the three-way catalyst 38 is positioned in an upstream region exposed to higher-temperature exhaust gas. However, the catalysts are not limited to such an arrangement, and the NOx reduction catalyst 40 may be positioned upstream of the three-way catalyst 38.

The turbine bypass channel 36 is connected, on its one end, to the first exhaust gas passage 32 on an upstream side of the turbine chamber 64 of the turbocharger 60, and connected, on the other end, to the second exhaust gas passage 34 on an upstream side of the three-way catalyst 38 in the exhaust gas discharge direction E. The turbine bypass channel 36 is equipped with a waste gate valve 42. The waste gate valve 42 has a function of regulating the supercharging pressure of intake gas boosted by the turbocharger 60. Further, the waste gate valve 42 also has a function of preventing the supercharging pressure from being increased to a predetermined value or greater, to thereby protect the engine 12 and the turbocharger 60 from being damaged.

The waste gate valve 42 is preferably composed of a solenoid valve, for example. An opening of the waste gate valve 42 is regulated in response to a signal from the combustion switching controller 11. As the opening of the waste gate valve 42 becomes greater, a portion of exhaust gas bypassed through the turbine bypass channel 36 into the second exhaust gas passage 34 rather than flowing into the turbine chamber 64 is increased. In this way, the engine 12 and the turbocharger 60 are protected from being damaged. Note that the turbine bypass channel 36 and the waste gate valve 42 correspond to a “supercharging pressure regulating device” in this invention.

The exhaust gas returning device 50 is installed between the second intake gas passage 24 and the first exhaust gas passage 32. The exhaust gas returning device 50 includes an exhaust gas return passage 52, which connects the first exhaust gas passage 32 to the second intake gas passage 24, and an exhaust gas return quantity regulating valve (an exhaust gas return quantity regulating device) 54 disposed at some midpoint in the exhaust gas return passage 52. An opening of the exhaust gas return quantity regulating valve 54 is regulated in response to a signal from the intake and exhaust controller 28. Upon receipt of a command from the combustion switching controller 11, the intake and exhaust controller 28 transmits the signal for regulating the opening to the exhaust gas return quantity regulating valve 54. In this way, the opening of the exhaust gas return quantity regulating valve 54 is regulated, to thereby adjust the quantity of exhaust gas to be returned or recirculated from the first exhaust gas passage 32 through the exhaust gas return passage 52 into the second intake gas passage 24.

The turbocharger 60 includes a compressor wheel 63 housed in the compressor chamber 62, a turbine 65 housed in the turbine chamber 64, and a shaft 66 for connecting the compressor wheel 63 and the turbine 65. The exhaust gas blown from the first exhaust gas passage 32 onto the turbine 65 within the turbine chamber 64 causes the turbine 65 to rotate, and power of the rotation is transmitted through the shaft 66 to the compressor wheel 63. The transmitted power causes the compressor wheel 63 to be rotatively driven for pressurizing air to be supplied through the second intake gas passage 24 into the engine 12 (i.e. supercharging the engine 12).

The combustion switching controller 11 is preferably composed of, for example, a microcomputer including a processing unit, a memory unit, an I/O interface, etc. The processing unit reads a program, data, and other values stored in the memory unit and executes the program. The memory unit stores, in addition to the program, the engine rotation speed Ne acquired and transmitted by the rotation speed sensor 20, the NOx reduction catalyst temperature T acquired and transmitted by the temperature sensor 41, maps, predetermined values, and other values.

Further, the combustion switching controller 11 transmits to the injection controller 18 a command signal for controlling the fuel injection quantity and injection timing of fuel into each cylinder 14 of the engine 12. Still further, the combustion switching controller 11 transmits to the intake and exhaust controller 28 a command signal for regulating the openings of the intake throttle valve 26 and the exhaust gas return quantity regulating valve 54. Moreover, the combustion switching controller 11 transmits to the waste gate valve 42 a signal for regulating the opening of the waste gate valve 42.

It should be noted that the combustion switching controller 11 may be formed as a tip integrated with at least one of the injection controller 18 and the intake and exhaust controller 28, or may be formed as a separate tip.

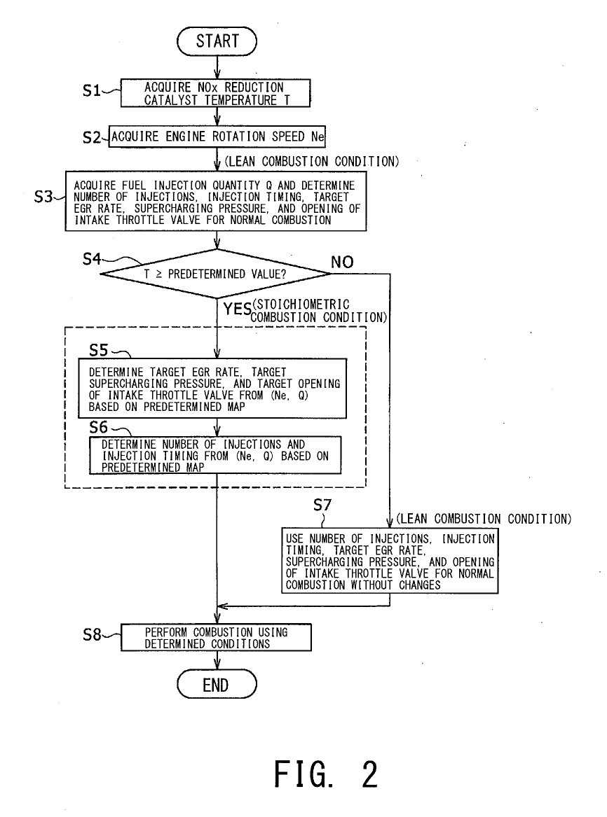

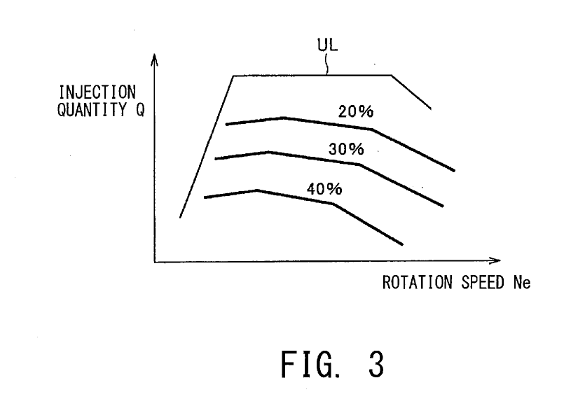

Next, referring to FIG. 2, control operation of the internal combustion engine 10 according to the present embodiment will be explained. FIG. 2 is a flowchart showing processing performed in the combustion switching controller 11 of the internal combustion engine 10 illustrated in FIG. 1. FIG. 3 is a graph representing an example of a map indicating EGR rates. The processing shown in FIG. 2 is repeatedly executed in the combustion switching controller 11 at intervals of a predetermined control period (such as, for example, 1 second).

As shown in FIG. 2, the combustion switching controller 11 initially acquires the NOx reduction catalyst temperature T in Step 1. For the NOx reduction catalyst temperature T, a value acquired by the temperature sensor 41 and stored in the memory unit may be used.

Next, in Step 2, the combustion switching controller 11 acquires the engine rotation speed Ne. For the engine rotation speed Ne, a value acquired by the rotation speed sensor 20 and stored in the memory unit may be used.

Then, in Step 3, the combustion switching controller 11 acquires a fuel injection quantity Q. For the fuel injection quantity Q, a value transmitted from the injection controller 18 and stored in the memory unit may be used. Further, in the same Step 3, the combustion switching controller 11 determines elements adopted as normal lean combustion conditions, such as the number of fuel injections, injection timing, a target EGR rate, a supercharging pressure, and the opening of the intake throttle valve 26, so as to satisfy operation conditions (such as a target torque Tg_tag and a target engine rotation speed Ne_tag) of the engine 12 input from an unillustrated host controller. In this determination, for example, various maps stored in the memory unit are referred to. For example, FIG. 3 shows the example of the map used for deriving the target EGR rate from the engine rotation speed Ne and the fuel injection quantity Q. It should be noted that a solid line UL drawn in FIG. 3 is an upper limit line representing operation limits in the engine 12.

Referring again to FIG. 2, the combustion switching controller 11 subsequently determines in Step 4 whether or not the NOx reduction catalyst temperature T is greater than or equal to a predetermined value. The predetermined value used in this step may be a value previously obtained by an experiment, a simulation, or the like and stored in the memory unit. In above-described Step 4, when an affirmative determination (YES) is obtained, operation moves to following Step 5, while, on the other hand, when a negative determination (NO) is obtained, operation moves to Step 7.

In the case of the affirmative determination in Step 4, the combustion switching controller 11 determines, in Step 5, the target EGR rate, a target supercharging pressure, a target opening of the intake throttle valve, and other values from the engine rotation speed Ne acquired in above-described Step 2 and the fuel injection quantity Q acquired in the above-described Step 3 based on a predetermined map, so as to establish a stoichiometric combustion mode as the combustion mode in the engine 12. Here, the target EGR rate, the supercharging pressure, and the intake throttle valve opening are determined in such a manner that the air-fuel ratio, which is a ratio between air and fuel, becomes equal to the stoichiometric ratio (of approximately 14.7:1) and the engine 12 is configured to perform stoichiometric combustion at a predetermined concentration of intake oxygen. Then, the combustion switching controller 11 determines, in the following Step 6, the number of injections and injection timing from the engine rotation speed Ne and the fuel injection quantity Q based on the predetermined map.

On the other hand, in the case of the negative determination in Step 4, the combustion switching controller 11 uses, in subsequent Step 7, as the lean combustion conditions, the fuel injection quantity Q acquired in above-described Step 3 as well as the number of fuel injections, the injection timing, the target EGR rate, the supercharging pressure, and the intake throttle valve opening determined also in Step 3 without changes. In other words, the combustion switching controller 11 maintains the determined results in Step 3 unchanged.

Then, in Step 8, the combustion switching controller 11 performs combustion under the conditions determined in Steps 5 and 6 or under the conditions determined in Step 7. Specifically, when the combustion is performed in the engine 12 under the conditions determined in Steps 5 and 6, the combustion mode is switched from the lean combustion mode to the stoichiometric combustion mode, or the combustion mode of the stoichiometric combustion mode is maintained. On the other hand, when the combustion is performed in the engine 12 under the conditions determined in Step 7, the lean combustion mode is used as the combustion mode.

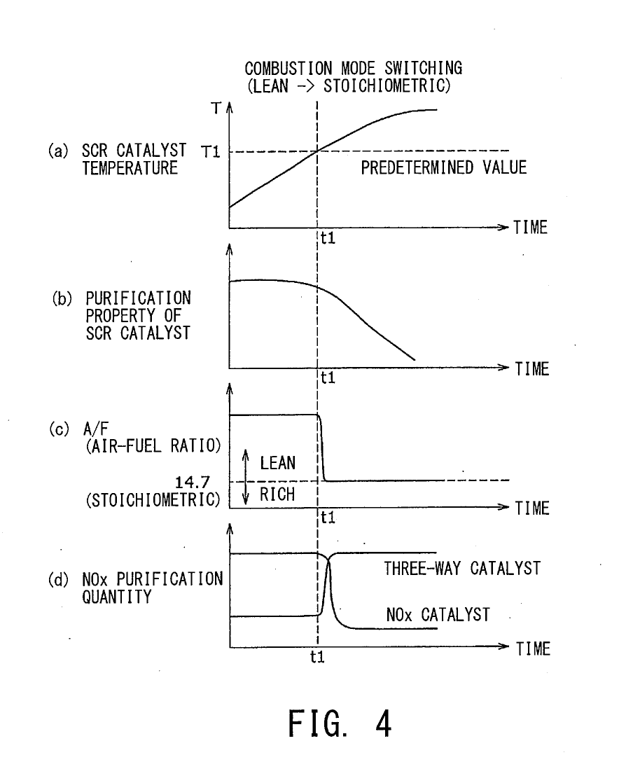

FIG. 4 shows graphs (a) representing the temperature of the NOx reduction catalyst 40, (b) representing the purification property of the SCR catalyst, (c) representing a change in the air-fuel ratio caused by switching the combustion modes, and (d) representing quantities of NOx purified in the three-way catalyst 38 and in the NOx reduction catalyst 40. In each of the graphs (a) to (d) in FIG. 4, the abscissa represents time.

As shown on the graph (a) in FIG. 4, as time progresses in a state where the lean combustion mode is performed as a normal combustion mode in the engine 12, the NOx reduction catalyst temperature T is gradually elevated. Then, at a point in time t1, the NOx reduction catalyst temperature T reaches or exceeds a predetermined value T1. When the temperature T of the NOx reduction catalyst 40 reaches or exceeds the predetermined value T1 as described above, the NOx reduction catalyst 40 experiences deterioration in its NOx purification property, resulting in a reduced NOx purification quantity as shown on graphs (b) and (d) of FIG. 4. On the other hand, as can be seen from the graph (d) in FIG. 4, the three-way catalyst 38 has a property that its NOx purification quantity is increased under a condition that the air-fuel ratio is close to the stoichiometric ratio, while the NOx purification quantity is decreased under the other conditions. The property of the three-way catalyst 38 is maintained even when its temperature is elevated.

In light of the above-described NOx purification properties of the three-way catalyst 38 and the NOx reduction catalyst 40, the internal combustion engine 10 of this embodiment is configured in such a manner that when the NOx reduction catalyst temperature T acquired by the temperature sensor 41 is elevated to a temperature of the predetermined value T1 or higher, the combustion mode of the engine 12 is switched from the lean combustion mode to the stoichiometric combustion mode as shown in the graphs (a) and (c) of FIG. 4. In this way, the NOx contained in the exhaust gas can be purified not by the NOx reduction catalyst 40 whose NOx purification efficiency is decreased, but by the three-way catalyst 38 whose NOx purification efficiency is increased under the condition that the air-fuel ratio becomes close to the stoichiometric ratio. Thus, according to the internal combustion engine 10 of this embodiment, even when the NOx reduction catalyst 40 is heated to high temperatures due to high-load operation of the engine 12, resulting in deteriorated NOx purification property, the NOx can be sufficiently purified in the three-way catalyst 38 for reducing the quantity of NOx emissions from the internal combustion engine 10.

### Second Embodiment

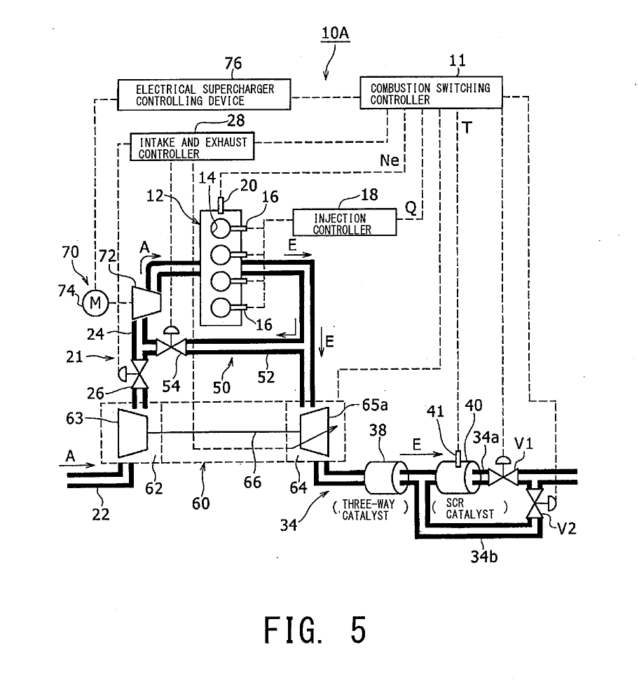

Next, referring to FIGS. 5 to 7, an internal combustion engine 10A according to a second embodiment of this invention will be described. FIG. 5 schematically shows an overall configuration of the internal combustion engine 10A of the second embodiment. Hereinafter, the same components as those of the internal combustion engine 10 in the first embodiment are designated by the same reference numerals as those of the first embodiment and descriptions related to the components will not be repeated.

As shown in FIG. 5, the internal combustion engine 10A further includes an electrically operated compressor 70. The electrically operated compressor 70 is disposed in the second intake gas passage 24 downstream of the intake throttle valve 26 in the intake direction and also downstream of a merging point of the second intake gas passage 24 with the exhaust gas return passage 52 in the intake direction. In the second embodiment, the turbocharger 60 and the electrically operated compressor 70 constitute the “supercharger” in this invention.

The electrically operated compressor 70 includes a compressor wheel 72 and a motor 74. The compressor wheel 72 is rotatively driven by the motor 74. Actuation of the motor 74 is controlled by an electrically operated supercharger controlling device 76. The electrically operated supercharger controlling device 76 drives the motor 74 to rotate in response to a command from the combustion switching controller 11. Air supplied to the engine 12 is pressurized (i.e. supercharged) by rotation of the compressor wheel 72 driven by the motor 74. Therefore, in addition to the supercharging pressure created by the turbocharger 60, the supercharging pressure of intake air is also controlled by the electrically operated compressor 70 in the second embodiment. When the electrically operated compressor 70 is installed, a sufficient supercharging pressure can be swiftly obtained upon the occurrence of a change in the operation state of the internal combustion engine, to thereby reduce a quantity of NOx generation. Here, the motor 74 of the electrically operated compressor 70 according to the second embodiment constitutes a part of the “supercharging pressure regulating device” in this invention.

Meanwhile, the turbocharger 60 in the internal combustion engine 10A of the second embodiment includes a turbine 65a with a variable nozzle vane capable of changing a flow velocity of exhaust gas. The flow velocity of exhaust gas impinging on the turbine 65a can be changed by the variable nozzle vane, to regulate the supercharging pressure created by the turbocharger 60. The opening of the variable nozzle vane is regulated in response to a command from the combustion switching controller 11. Because, in the turbocharger 60 of the second embodiment, the variable nozzle vane can function to prevent the supercharging pressure from reaching or exceeding a predetermined value, the exhaust gas bypass channel and the waste gate valve provided in the internal combustion engine 10 according to the first embodiment are not installed. Note that the variable nozzle vane in the second embodiment constitutes a part of the “supercharging pressure regulating device” in this invention.

Further, in the internal combustion engine 10A of the second embodiment, the second exhaust gas passage 34 is branched between the three-way catalyst 38 and the NOx reduction catalyst 40 into a main exhaust gas channel 34a and an exhaust gas bypass channel 34b. The main exhaust gas channel 34a is a passage for directing the exhaust gas to flow through the NOx reduction catalyst 40, and is equipped with a first switching valve V1. On the other hand, the exhaust gas bypass channel 34b branched between the three-way catalyst 38 and the NOx reduction catalyst 40 is a passage for directing the exhaust gas to bypass the NOx reduction catalyst 40, and is merged into the main exhaust channel 34a downstream of the first switching valve V1. Further, the exhaust gas bypass channel 34b is equipped with a second switching valve V2. The openings of the first and second switching valves V1 and V2 are regulated based on a command from the combustion switching controller 11. Therefore, in the internal combustion engine 10A of the second embodiment, both the main exhaust gas channel 34a for directing the exhaust gas to flow through the NOx reduction catalyst 40 and the exhaust gas bypass channel 34b are configured to be selectively switchable by means of the first and second switching valves V1 and V2. Note that the first and second switching valves V1 and V2 constitute a “channel switching device” in this invention.

The components of the internal combustion engine 10A in the second embodiment other than those described above are identical to those of the first embodiment, and the descriptions related to the components are not repeated.

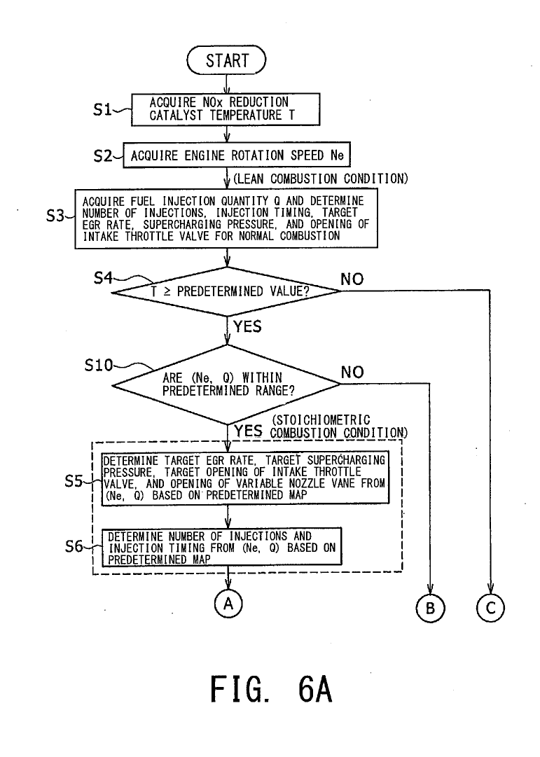

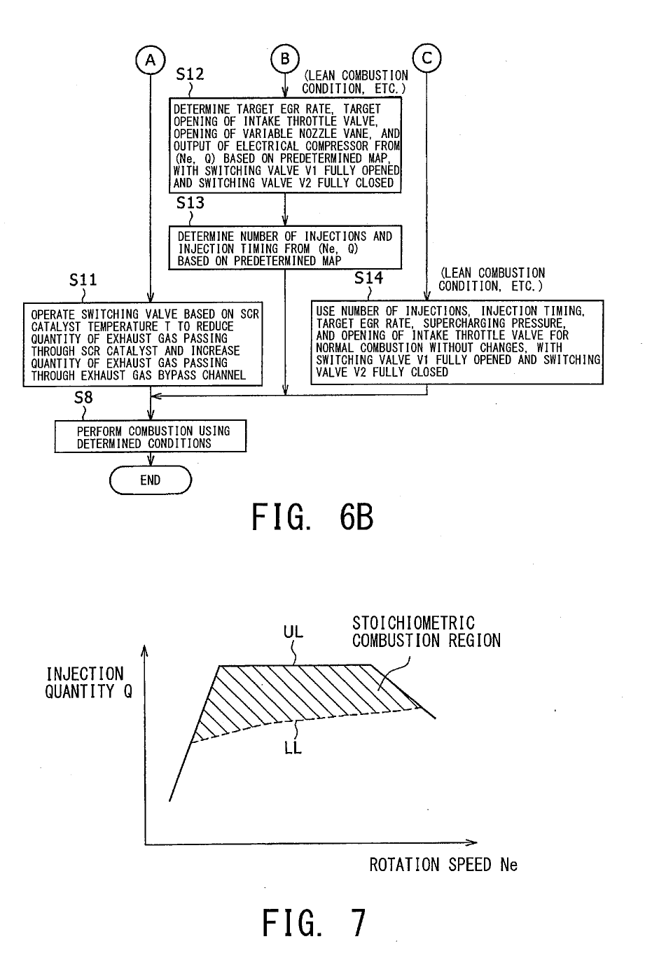

Next, referring to FIGS. 6A, 6B, and 7, control operation in the internal combustion engine 10A of the second embodiment will be described. FIGS. 6A and 6B are flowcharts representing processing performed in the combustion switching controller 11 of the internal combustion engine 10A. FIG. 7 is a graph representing an example of a map on which a lower limit is set to a stoichiometric combustion region.

In the processing shown in FIGS. 6A and 6B, Steps 1 to 6 and Step 8 are almost the same as those described above in the first embodiment. Thus, processing (in Steps 10 to 14) different from that of the first embodiment will be mainly described below.

As shown in FIGS. 6A and 6B, the combustion switching controller 11 initially performs processing in Steps 1 to 4, and moves to Step 10 when an affirmative determination (YES) is obtained in Step 4, or moves to Step 14 when a negative determination (NO) is obtained in Step 4.

In the case of the affirmative determination in above-described Step 4; i.e., when the NOx reduction catalyst temperature T is greater than or equal to the predetermined value, the combustion switching controller 11 determines in subsequent Step 10 whether or not the engine rotation speed Ne and the fuel injection quantity Q are contained in a predetermined range. Here, the combustion switching controller 11 refers to the map shown in FIG. 7 to perform the determination in Step 10.

Specifically, a lower limit line LL is established in the stoichiometric combustion region on the map as shown in FIG. 7, and it is determined whether or not the engine rotation speed Ne and the fuel injection quantity Q obtained in Steps 2 and 3 are contained in a hatched region enclosed with an upper limit line UL and the lower limit line LL. The stoichiometric combustion region is thus limited by the lower limit line LL in light of processing capacity of a post processing device, such as an unillustrated diesel particulate filter (DPF), because smoke (soot) can be generated more easily in a region below the lower limit line LL.

Referring again to FIG. 6A, when the affirmative determination (YES) is made in above-described Step 10; i.e., when the engine rotation speed Ne and the fuel injection quantity Q are determined to be within the predetermined stoichiometric combustion region, the combustion switching controller 11 performs processing in Steps 5 and 6 in which the target EGR rate, the target supercharging pressure, the target opening of the intake throttle valve, the opening of the variable nozzle vane, and other values are determined so as to establish or maintain the stoichiometric combustion mode as the combustion mode of the engine 12. Here, the quantity of intake air is defined to make the air-fuel ratio, which is the ratio between air and fuel, equal to the stoichiometric ratio (of approximately 14.7:1). Then, the combustion switching controller 11 determines, in the following Step 6, the number of injections and injection timing from the engine rotation speed Ne and the fuel injection quantity Q based on a predetermined map.

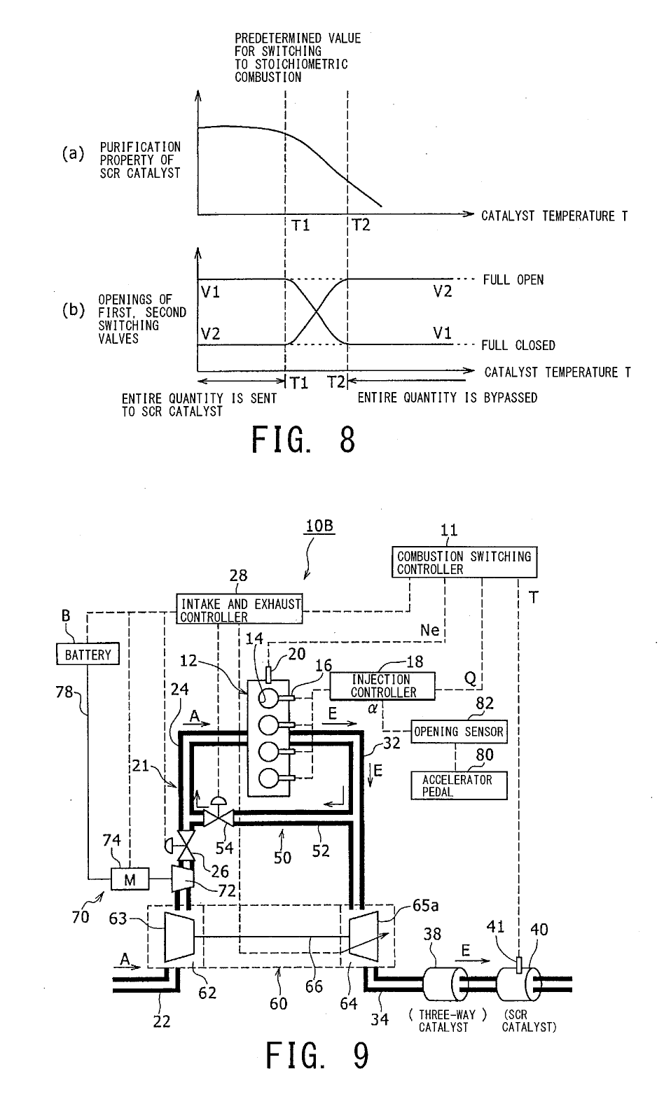

Subsequently, the combustion switching controller 11 operates, in Step 11, the first and second switching valves V1 and V2 based on the NOx reduction catalyst temperature T to decrease a quantity of the exhaust gas passing along the main exhaust gas channel 34a through the NOx reduction catalyst 40 and increase a quantity of the exhaust gas passing through the exhaust gas bypass channel 34b. Such operation of the first and second switching valves V1 and V2 will be explained with reference to FIG. 8.

FIG. 8 shows graphs (a) representing the change in the purification property of the NOx reduction (SCR) catalyst 40 and (b) representing a regulated state of each passage quantity of the exhaust gas through the three-way catalyst 38 and the exhaust gas through the NOx reduction catalyst 40. As shown in the graph (a) in FIG. 8, although the purification property of the NOx reduction catalyst 40 is deteriorated after the NOx reduction catalyst temperature T exceeds the predetermined value T1, the NOx contained in the exhaust gas is eliminated/purified, as described in the first embodiment, by the three-way catalyst 38 whose NOx purification property is enhanced because the air-fuel ratio becomes equal to the stoichiometric ratio.

After the combustion state of the engine 12 transitions to the stoichiometric combustion mode, the stoichiometric combustion mode will be continued as long as the NOx reduction catalyst 40 has an elevated temperature greater than or equal to the predetermined value T1, which may raise a problem in that the fuel efficiency is lowered. With this in view, control operation for reducing the quantity of exhaust gas passing through the NOx reduction catalyst 40 is performed in the above-described Step 11 to lower the NOx reduction catalyst temperature T below the predetermined value T1. More specifically, as shown in graphs (a) and (b) in FIG. 8, when the NOx reduction catalyst temperature T is lower than the predetermined value T1, the first switching valve V1 is fully opened and the second switching valve V2 is fully closed, which allows the entire quantity of the exhaust gas to pass through the NOx reduction catalyst 40 along the main exhaust gas channel 34a. When the NOx reduction catalyst temperature T reaches or exceeds the predetermined value T1, the opening of the first switching valve V1 is decreased, while the opening of the second switching valve V2 is increased. In this way, the quantity of the exhaust gas passing through the NOx reduction catalyst 40 along the main exhaust gas channel 34a is decreased, while the quantity of the exhaust gas passing through the exhaust gas bypass channel 34b is increased. Further, when the NOx reduction catalyst temperature T reaches or exceeds a value T2 greater than the predetermined value T 1, the first switching valve V1 is fully closed, while the second switching valve V2 is fully opened, to establish a state where the entire quantity of the exhaust gas is directed to pass through the exhaust gas bypass channel 34 and no exhaust gas flows through the NOx reduction catalyst 40. As a result of this, the NOx reduction catalyst temperature T can be lowered below the predetermined value T1, which allows the combustion mode of the engine 12 to be changed from the stoichiometric combustion mode to the normal lean combustion mode.

It should be noted that although the state where both of the first and second switching valves V1 and V2 are open at temperatures between the temperatures T1 and T2 has been described in the example shown in the graph (b) in FIG. 8, the present invention is not limited to the example. For example, at the time when the NOx reduction catalyst temperature T is elevated to the predetermined value T 1, the first switching valve V1 may be fully closed, while the second switching valve V2 may be fully opened.

Referring again to FIGS. 6A and 6B, when the negative determination (NO) is obtained in Step 4; i.e., when the NOx reduction catalyst temperature T is lower than the predetermined value T1, the combustion switching controller 11 uses, in subsequent Step 14, the number of fuel injections, the injection timing, the target EGR rate, the supercharging pressure, and the opening of the intake throttle valve determined in the above-described Step 3 as the lean combustion conditions without changes. Then, the combustion switching controller 11 operates the first switching valve V1 to be fully opened and the second switching valve V2 to be fully closed, for allowing the entire quantity of the exhaust gas to pass through the NOx reduction catalyst 40. In this way, the NOx contained in the exhaust gas is efficiently purified by the NOx reduction catalyst 40. As a result of this, the quantity of NOx emissions can be reduced.

As shown in FIG. 6A, when the negative determination (NO) is obtained in the above-described Step 10, the combustion switching controller 11 determines, in subsequent Step 12 as shown in FIG. 6B, the target EGR rate, the target opening of the intake throttle valve, the opening of the variable nozzle vane, and a motor output of the electrically operated compressor 70 from the engine rotation speed Ne and the fuel injection quantity Q based on the predetermined map, so as to establish a high supercharging lean combustion mode as the combustion mode of the engine 12. Further, in this step, the combustion switching controller 11 operates the first switching valve V1 to be fully opened, and the second switching valve V2 to be fully closed. This establishes the state in which the entire quantity of the exhaust gas is passed through the NOx reduction catalyst 40. Then, in subsequent Step 13, the combustion switching controller 11 similarly determines from the engine rotation speed Ne and fuel injection quantity Q based on the predetermined map, the number of fuel injections and the injection timing.

When the lean combustion mode is initiated under the conditions determined as described above, lean combustion can be carried out with air whose quantity is greater than that in normal combustion. As a result, the combustion temperature is decreased, and the quantity of NOx generation can be accordingly reduced. Further, because the quantity of NOx generation is minimized even though the NOx reduction catalyst 40 is deteriorated in its NOx purification property due to the elevated temperature greater than or equal to the predetermined value T1, a smaller quantity of NOx is discharged from the engine 12, which can contribute to a reduced quantity of NOx emissions from the internal combustion engine 10A to the outside.

Then, in Step 8, the combustion switching controller 11 causes combustion under the conditions determined in Steps 5 and 6, Steps 12 and 13, or Step 14. That is, when combustion is carried out in the engine 12 under the conditions determined in Steps 5 and 6, the combustion mode is switched from the lean combustion mode to the stoichiometric combustion mode, or the stoichiometric combustion mode is maintained. On the other hand, when combustion is performed in the engine 12 under the conditions determined in Step 14, the normal lean combustion mode is applied, and when combustion is performed in the engine 12 under the conditions determined in Steps 12 and 13, the high supercharging lean combustion mode is applied, in which the supercharging pressure is greater than that in normal operation.

As described above, the internal combustion engine 10A of the second embodiment can also provide the same effect as that of the first embodiment. That is, even when the NOx purification property is deteriorated due to the elevated temperature of the NOx reduction catalyst 40, switching from the lean combustion mode to the stoichiometric combustion mode can cause NOx to be sufficiently purified in the three-way catalyst 38 which is increased in temperature and accordingly enhanced in its activity. As a result of this, the quantity of NOx emissions from the internal combustion engine 10A can be reduced.

### Third Embodiment

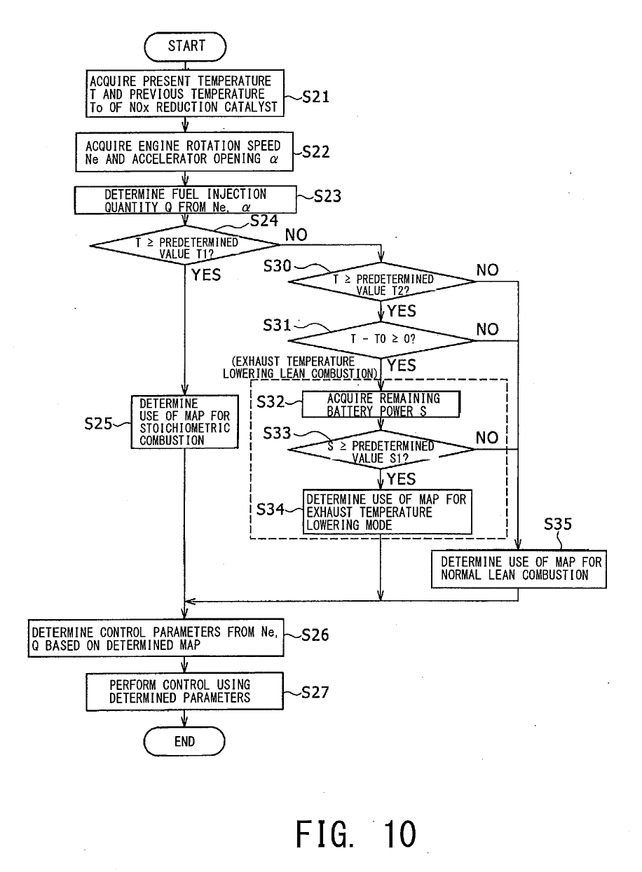

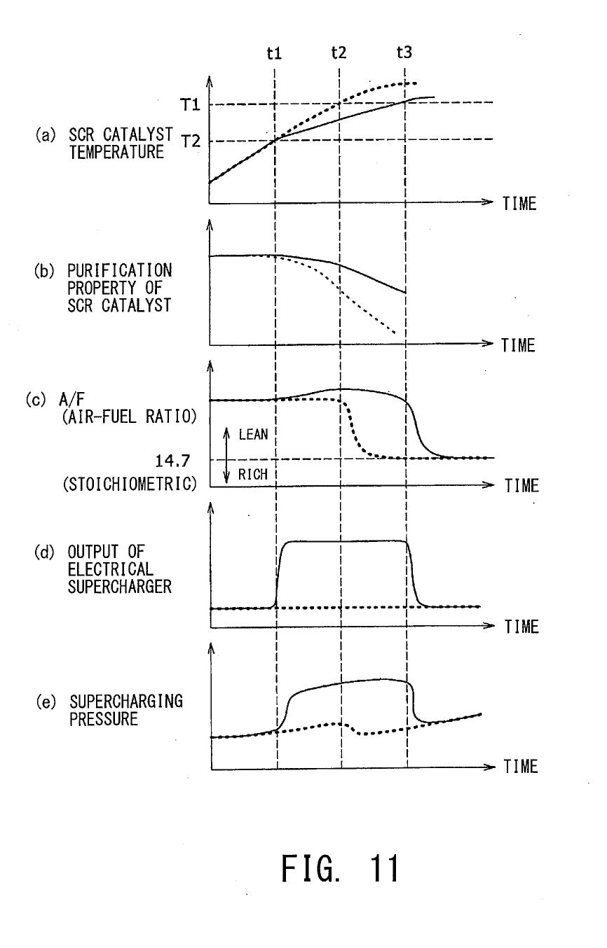

Referring next to FIGS. 9 to 11, an internal combustion engine 10B according a third embodiment will be described. FIG. 9 schematically shows an overall configuration of the internal combustion engine 10B according to the third embodiment. The following description is focused on points of difference between the internal combustion engine 10B and the above-described internal combustion engines 10 and 10A in the first and second embodiments. The same components as those of the first and second embodiments are designated by the same reference numerals as those of the first and second embodiments, and the descriptions related to the components will not be repeated.

As shown in FIG. 9, the internal combustion engine 10B of the third embodiment includes the turbocharger 60 functioning as a main supercharger and the electrically operated compressor 70 functioning as an auxiliary supercharger. The turbocharger 60 has the turbine 65a with the variable nozzle vane for changing the flow velocity of the exhaust gas. The flow velocity of the exhaust gas impinging on the turbine 65a can be changed by means of the variable nozzle vane, to thereby regulate supercharging pressure exerted by the turbocharger 60. The opening of the variable nozzle vane is regulated in response to the command received via the intake and exhaust controller 28 from the combustion switching controller 11. This configuration is identical to that of the internal combustion engine 10A of the second embodiment.

In the internal combustion engine 10B, the compressor wheel 72 of the electrically operated compressor 70 is disposed between the compressor chamber 62 of the turbocharger 60 and the intake throttle valve 26. In other words, in the internal combustion engine 10B, the electrically operated compressor 70 is installed upstream in the intake direction A from a connection site of the exhaust gas return passage 52 connected to the second intake gas passage 24.

The internal combustion engine 10B is equipped with a battery B. The motor 74 of the electrically operated compressor 70 is actuated with power supplied through an electric line 78 from the battery B. The combustion switching controller 11 is notified of the remaining power of the battery B through transmission from the intake and exhaust controller 28. It should be noted that, in the third embodiment, because the intake and exhaust controller 28 also functions as a controller of the electrically operated compressor 70, the electrically operated supercharger controlling device 76 employed in the second embodiment is not provided. In addition, the motor 74 of the electrically operated compressor 70 corresponds to a supercharging pressure regulating device for the auxiliary supercharger.

A vehicle in which the internal combustion engine 10B is installed has an accelerator pedal 80. The accelerator pedal 80 has an opening sensor 82. An opening of the accelerator pedal 80 (hereinafter referred to as an “accelerator opening”) a detected by the opening sensor 82 is transmitted via the injection controller 18 to the combustion switching controller 11.

The second exhaust gas passage 34 in the internal combustion engine 10B of the third embodiment is the same as that in the internal combustion engine 10 of the first embodiment, and is not provided with an exhaust gas bypass channel or a switching valve for switching channels. The components in the internal combustion engine 10B other than those described above are identical to those of the internal combustion engines 10 and 10A in the first and second embodiments.

Next, referring to FIG. 10, control operation in the internal combustion engine 10B of the third embodiment will be described. FIG. 10 is a flowchart showing processing performed in the combustion switching controller 11 of the internal combustion engine 10B illustrated in FIG. 9.

As shown in FIG. 10, the combustion switching controller 11 initially acquires a present temperature T and a previous temperature T0 of the NOx reduction catalyst 40 in Step 21. For the present temperature T, a value acquired in the present processing by the temperature sensor 41 and stored in the memory unit may be used. On the other hand, the previous temperature T0 may be assigned a value which has been acquired in previous processing performed earlier by a predetermined period of time (for example, 1 second) and stored in the memory unit.

Then, the combustion switching controller 11 acquires, in Step 22, the engine rotation speed Ne and the accelerator opening α. For the engine rotation speed, the value acquired by the rotation speed sensor 20 and stored in the memory unit may be used. For the accelerator opening α, a value acquired by the opening sensor 82 and stored in the memory unit may be used.

Subsequently, in Step 23, the combustion switching controller 11 determines the fuel injection quantity Q based on the engine rotation speed Ne and the accelerator opening α acquired in above-described Steps 21 and 22. The fuel injection quantity Q may be determined, for example, by referring to a map previously stored in the memory unit using the engine rotation speed Ne and the accelerator opening α as arguments.

Next, in Step 24, the combustion switching controller 11 determines whether or not the present temperature T of the NOx reduction catalyst 40 is greater than or equal to the predetermined value T1. When an affirmative determination (YES) is obtained in Step 24, operation moves to Step 25, whereas when a negative determination (NO) is obtained in Step 24, operation moves to Step 30.

In the case of the affirmative determination in Step 24, the combustion switching controller 11 determines the use of a map for stoichiometric combustion in Step 25. Then, in the following Step 26, the combustion controller 11 determines control parameters for the stoichiometric combustion mode from the engine rotation speed Ne and the fuel injection quantity Q based on the determined map. Here, the “control parameters” include the target EGR rate, the target supercharging pressure, the opening of the intake throttle valve, the output of the electrically operated compressor, the number of fuel injections, and the fuel injection timing.

Next, in Step 27, the combustion switching controller 11 performs control operation using the determined control parameters. Specifically, the combustion switching controller 11 controls the engine 12 to be operated in the stoichiometric combustion mode. Here, the control operation is identical to that in Steps 1 to 6 and Step 8 performed in the internal combustion engine 10 of the first embodiment explained with reference to FIG. 2.

On the other hand, in the case of the negative determination in above-described Step 24; i.e., when the present temperature T of the NOx reduction catalyst 40 is lower than the predetermined value T1, the combustion switching controller 11 determines in Step 30 whether or not the present temperature T of the NOx reduction catalyst 40 is greater than or equal to the predetermined value T2 (where T2<T1). In this Step 30, when an affirmative determination (YES) is obtained, operation moves to Step 31, whereas when a negative determination (NO) is obtained, operation moves to Step 35.

When the negative determination is obtained in above-described Step 30; i.e. when the present temperature T of the NOx reduction catalyst 40 is lower than the predetermined value T2, the combustion switching controller 11 determines, in Step 35, the use of a map for normal lean combustion. Then, in above-described Steps 26 and 27, the combustion switching controller 11 determines the control parameters from the engine rotation speed Ne and the fuel injection quantity Q based on the determined map, and performs control operation using the determined control parameters. In other words, the combustion switching controller 11 controls the engine 12 to be operated in the normal lean combustion mode. Note that, the control operation is identical to that in Steps 1 to 4 and Steps 7 and 8 performed in the internal combustion engine 10 of the first embodiment explained with reference to FIG. 2.

On the other hand, when the affirmative determination is obtained in above-described Step 30; i.e., the present temperature T of the NOx reduction catalyst 40 is greater than or equal to the predetermined value T2, the combustion switching controller 11 determines, in Step 31, whether or not a value calculated by subtracting the previous temperature T0 from the present temperature T of the NOx reduction catalyst 40 is no smaller than 0. When a negative determination (NO) is obtained in Step 31; i.e., when the temperature of the NOx reduction catalyst 40 is on a downward trend, because it is unnecessary that the combustion modes should be switched to lower the temperature of the NOx reduction catalyst 40, the combustion switching controller 11 moves to Step 35 for carrying out operation in the normal lean combustion mode.

As opposed to this, when the affirmative determination (YES) is obtained in above-described Step 31; i.e., when the temperature of the NOx reduction catalyst 40 is on an upward trend, the combustion switching controller 11 acquires a remaining battery power S in Step 32, and determines, in the following Step 33, whether or not the acquired remaining battery power S is greater than or equal to a predetermined value 51. The determination is performed with the intention of checking whether the remaining battery power S is sufficient for actuating the motor 74 of the electrically operated compressor 70.

When a negative determination (NO) is obtained in the above-described Step 33, the combustion switching controller 11 proceeds to perform processing in Step 35 to carry out operation in the normal lean combustion mode. On the other hand, when an affirmative determination is obtained in the above-described Step 33, the combustion switching controller 11 determines, in Step 34, the use of a map for an exhaust gas temperature lowering mode. The map for the exhaust gas temperature lowering mode is a map for a lean combustion in which the target supercharging pressure and the output of the electrically operated compressor 70 are set at greater values than those in the map for the normal lean combustion mode. In other words, the exhaust gas temperature lowering mode is a control mode employed to increase the supercharging pressure by means of the electrically operated compressor 70 for lowering the exhaust gas temperature.

Then, in Steps 26 and 27, the combustion switching controller 11 determines the control parameters from the engine rotation speed Ne and the fuel injection quantity Q based on the map determined in Step 34, and carries out control operation using the determined control parameters. In other words, the combustion switching controller 11 controls the engine 12 to be operated in the exhaust gas temperature lowering lean combustion mode.

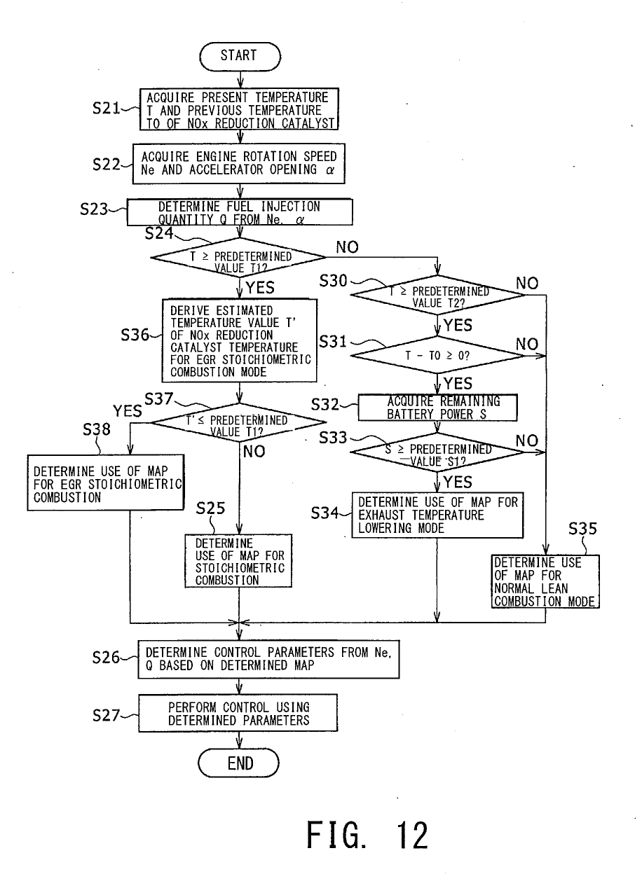

FIG. 11 shows graphs (a) representing the temperature of the NOx reduction (SCR) catalyst, (b) representing the purification property of the SCR catalyst, (c) representing the air-fuel ratio, (d) representing the output of the electrically operated supercharger, and (e) representing the supercharging pressure. In each of the graphs (a) to (e), time is plotted on the abscissa where time t1 is a point in time at which the SCR catalyst temperature exceeds the predetermined value T2, time t2 is a point in time at which the combustion mode is switched to the stoichiometric combustion mode not accompanied with the exhaust gas temperature lowering mode, and time t3 is a point in time at which the combustion mode is switched to the stoichiometric combustion mode accompanied with the exhaust gas temperature lowering mode. Further, in each of the graphs (a) to (e) of FIG. 11, the broken line represents a case of not using the exhaust gas temperature lowering mode, whereas the solid line represents a case of using the exhaust gas temperature lowering mode.

As shown on graphs (a) to (e) in FIG. 11, in the internal combustion engine 10B of the third embodiment, when the temperature of the NOx reduction catalyst 40 reaches or exceeds the predetermined value T2, the electrically operated supercharger is activated to increase the supercharging pressure, provided that the remaining battery power S is at a sufficient level, to thereby change the combustion mode of the engine 12 from the normal lean combustion mode to the exhaust gas temperature lowering mode. This increases the quantity of intake air supplied to the engine 12, and accordingly decreases the exhaust gas temperature, which can, in turn, prevent an increase in temperature of the NOx reduction catalyst 40. More specifically, in the instance of not using the exhaust gas temperature lowering mode, the temperature of the NOx reduction catalyst 40 reaches or exceeds the predetermined value T1 at time t2, which leads to the switching from the normal lean combustion mode to the stoichiometric combustion mode. As opposed to this, in the internal combustion engine 10B of the third embodiment, the use of the exhaust gas temperature lowering mode can cause the rise in temperature of the NOx reduction catalyst 40 to be slowed down to thereby defer the point in time at which the temperature of the NOx reduction catalyst 40 reaches or exceeds the predetermined value T1 to time t3. As a result of this, the timing of transition to the stoichiometric combustion mode can be also deferred, which can contribute to improved fuel efficiency while maintaining the quantity of NOx emissions unincreased.

As described above, according to the internal combustion engine 10B of the third embodiment, the supercharging pressure is increased by means of surplus power of the electrically operated compressor 70 serving as the auxiliary supercharger, to thereby increase the quantity of gas trapped within the cylinders 14 of the engine 12 and accordingly decrease the exhaust gas temperature. In this operation, because the fuel injection quantity remains unchanged between before and after the use of the exhaust gas temperature lowering mode, deterioration in fuel efficiency associated with the technique described in JP 2011-220214 A does not occur. Further, according to the internal combustion engine 10B of the third embodiment, even in a situation where the quantity of EGR gas cannot be increased as in the case of the technique described in U.S. Pat. No. 5,866,833 B, it is possible to lower the exhaust gas temperature while ensuring excellent response.

It should be noted that although the example in which the supercharging pressure is increased using the electrically operated compressor 70 in the exhaust gas temperature lowering mode has been described above, the present invention is not limited to the example. In the exhaust gas temperature lowering mode, the air-fuel ratio and the EGR rate may be controlled at the same time as the operation to increase the supercharging pressure by simultaneously controlling, in addition to the electrically operated compressor 70, the exhaust gas return quantity regulating valve 54, the intake throttle valve 26, and the variable nozzle vane of the turbocharger 60.

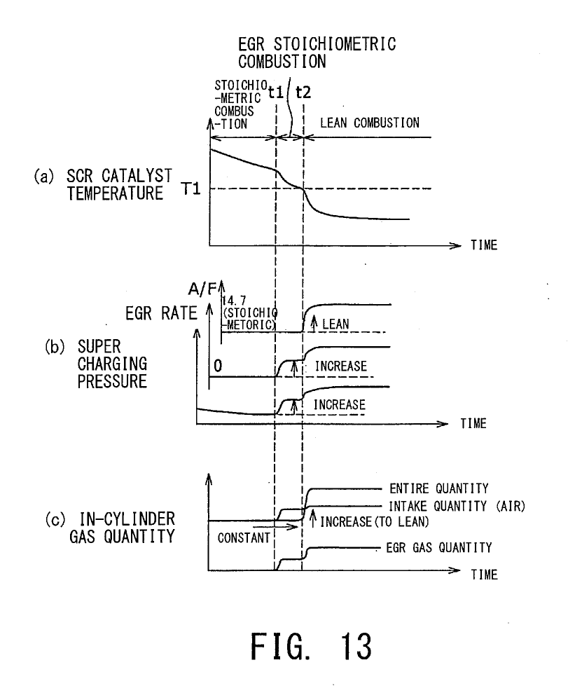

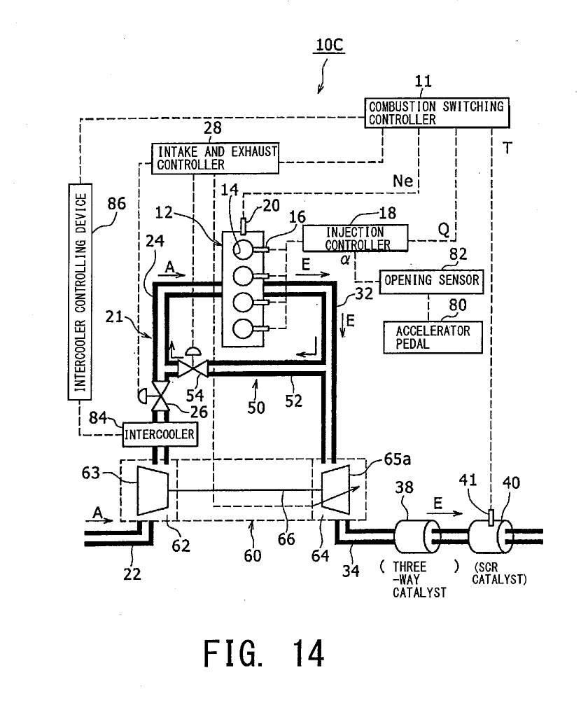

Referring next to FIGS. 12 and 13, another example of control operation in the internal combustion engine 10B of the third embodiment will be described. FIG. 12 is a flowchart representing another processing performed in the combustion switching controller 11 of the internal combustion engine 10B illustrated in FIG. 9. FIG. 13 shows graphs (a) representing the temperature of the NOx reduction (SCR) catalyst, (b) representing the supercharging pressure, the EGR rate, and the air-fuel (A/F) ratio, and (c) representing the quantity of in-cylinder gas.

The following description is focused on process steps different from those described above with reference to FIG. 10, while the same process steps as those in FIG. 10 are identified by the same step numbers, and the descriptions related to the steps will not be repeated. In the other processing shown in FIG. 12, Steps 21 to 27 and Steps 30 to 35 are identical to those described above with reference to FIG. 10 whereas Steps 36 to 38 are different from those described above.

When the present temperature T of the NOx reduction catalyst 40 is determined in Step 24 as matching or exceeding the predetermined value T1 (YES in Step 24), the combustion switching controller 11 derives an estimated temperature T′ of the NOx reduction catalyst 40 expected for the NOx reduction catalyst 40 in a case where an EGR stoichiometric combustion mode is carried out. The estimated temperature T′ may be derived, for example, using the engine rotation speed and torque as arguments, from a map which has been previously stored in the memory unit. Here, the “EGR stoichiometric combustion mode” means a stoichiometric combustion mode of using the motor 74 of the electrically operated compressor 70 and the exhaust gas return quantity regulating valve 54 in order to increase a returned quantity of the exhaust gas without changing an introduced quantity of intake air for the purpose of lowering the temperature of the exhaust gas.

Next, in Step 37, the combustion witching controller 11 determines whether or not the estimated temperature T′ derived in Step 36 is lower than or equal to the predetermined value T1. In this Step 37, when an affirmative determination (YES) is obtained, operation moves to Step 38, whereas when a negative determination (NO) is obtained, operation moves to Step 25. In the case of the negative determination; i.e., when it is expected that transition to the EGR stoichiometric combustion mode will not cause the estimated temperature T′ of the NOx reduction catalyst 40 to be lowered to the predetermined value T1 or below, the normal stoichiometric combustion mode is performed through processing in Steps 25, 26, and 27.

On the other hand, in the case of the affirmative determination in Step 37; i.e., when it is expected that transition to the EGR stoichiometric combustion mode will cause the estimated temperature T′ of the NOx reduction catalyst 40 to be lowered to the predetermined value T1 or below, the combustion switching controller 11 determines the use of a map for EGR stoichiometric combustion in Step 38. In the map for EGR stoichiometric combustion, both the target EGR rate and the target supercharging pressure are defined to have values greater than those in the map for normal stoichiometric combustion.

Then, the combustion switching controller 11 determines, in Step 26, the control parameters from the engine rotation speed Ne and the fuel injection quantity Q based on the map determined in Step 38, and performs, in Step 27, control operation using the determined control parameters. This switches the combustion mode of the engine 12 to the EGR stoichiometric combustion mode.

FIG. 13 shows graphs (a) representing the temperature of the NOx reduction (SCR) catalyst, (b) representing the supercharging pressure, the EGR rate and the air-fuel (A/F) ratio, and (c) representing the quantity of in-cylinder gas. In each of the graphs (a) to (c) of FIG. 13, time is plotted on the abscissa on which time t1 is a point in time at which the transition to the EGR stoichiometric combustion mode will cause the expected temperature T′ of the NOx reduction catalyst 40 to be lowered to the predetermined value T1 or below, and time t2 is a point in time at which the temperature T of the NOx reduction catalyst 40 is actually lowered to the predetermined value T1 or below.

As shown in the graph (b) in FIG. 13, at time t1, stoichiometric combustion is performed in a state where both the EGR rate and the supercharging pressure are increased, while the air-fuel ratio is maintained at the stoichiometric ratio (of approximately 14.7:1). In the stoichiometric combustion at this time, although the quantity of intake gas (air) remains unchanged, the quantity of EGR gas is increased, resulting in an increased total quantity of in-cylinder gas as shown in the graph (c) of FIG. 13. When the EGR stoichiometric combustion mode is performed with the increased EGR rate and the increased supercharging pressure as described above, the exhaust gas temperature is lowered. This facilitates a temperature drop of the NOx reduction catalyst 40 as shown in graph (a) of FIG. 13 to the predetermined value T1 or below, at which it becomes possible to switch the stoichiometric combustion mode to the lean combustion mode. Therefore, the length of time of operation in the stoichiometric combustion mode can be shortened, which can contribute to improvement in fuel efficiency.

### Fourth Embodiment

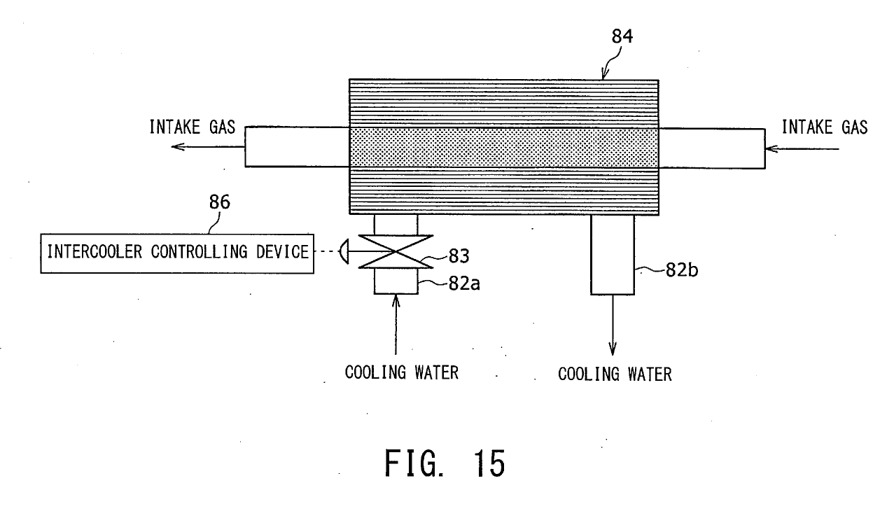

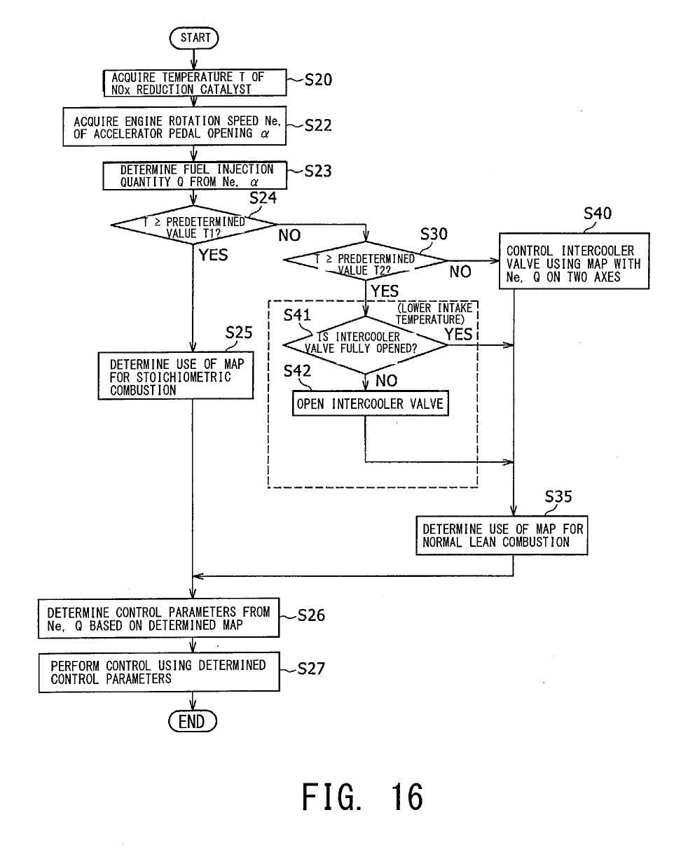

Next, an internal combustion engine according to a fourth embodiment will be described with reference to FIGS. 14 to 17. FIG. 14 schematically shows an overall configuration of an internal combustion engine 10C of the fourth embodiment. FIG. 15 shows an intercooler 84 illustrated in FIG. 14. In the following description, the internal combustion engine 10C in the fourth embodiment is explained, focusing on its configuration different from that in the first embodiment. The same components as those of the internal combustion engines 10, 10A, and 10B according to the first to third embodiments are designated by the same reference numerals as those of the first to third embodiments, and as appropriate the descriptions related to the components will not be repeated.

As shown in FIG. 14, the internal combustion engine 10C includes the intercooler 84. The intercooler 84 has a function of cooling air introduced into the engine 12 through the intake system 21. The intercooler 84 is disposed downstream of the turbocharger 60 in the intake direction (the arrow A direction). More specifically, the intercooler 84 is positioned between the compressor chamber 62 and the intake throttle valve 26 in the second intake gas passage 24.

As shown in FIG. 15, a cooling device of a water cooling type is preferably used for the intercooler 84. The intercooler 84 has a feed pipe 82a and a discharge pipe 82b for cooling water, and the feed pipe 82a is equipped with an intercooler valve 83 for regulating the quantity of cooling water. The opening of the intercooler valve 83 is regulated in response to a command from an intercooler controlling device 86. In this way, the intercooler 84 is configured to have a variable intake gas cooling power which can be changed by regulating the quantity of cooling water to be supplied.

Referring again to FIG. 14, the intercooler controlling device 86 is electrically connected to the combustion switching controller 11. The combustion switching controller 11 can regulate the opening of the intercooler valve 83 via the intercooler controlling device 86, to thereby control the cooling power of the intercooler 84.

It should be noted that the cooling power of the intercooler 84 may be changed by changing the temperature of cooling water. Further, the intercooler 84 is not limited to that of the water cooling type, and may be of an air cooling type. In the case of the air cooling type, the cooling power can be changed by changing the quantity of cooling air.

In the internal combustion engine 10C of the fourth embodiment, the turbocharger 60 includes the turbine 65a with a variable nozzle vane capable of changing the flow velocity of exhaust gas. The flow velocity of exhaust gas impinging on the turbine 65a can be changed by the variable nozzle vane, to thereby regulate the supercharging pressure created by the turbocharger 60. The opening of the variable nozzle vane is regulated in response to the command from the combustion switching controller 11. This point is the same as that of the internal combustion engine 10A in the second embodiment.

It should be noted that similarly with the internal combustion engine 10B of the third embodiment, the accelerator pedal 80 and the accelerator opening sensor 82 are provided in the internal combustion engine 10C, to transmit the signal indicative of the accelerator opening α via the injection controller 18 to the combustion switching controller 11. The components of the internal combustion engine 10C in the fourth embodiment other than those described above are the same as those of the internal combustion engine 10 in the first embodiment.

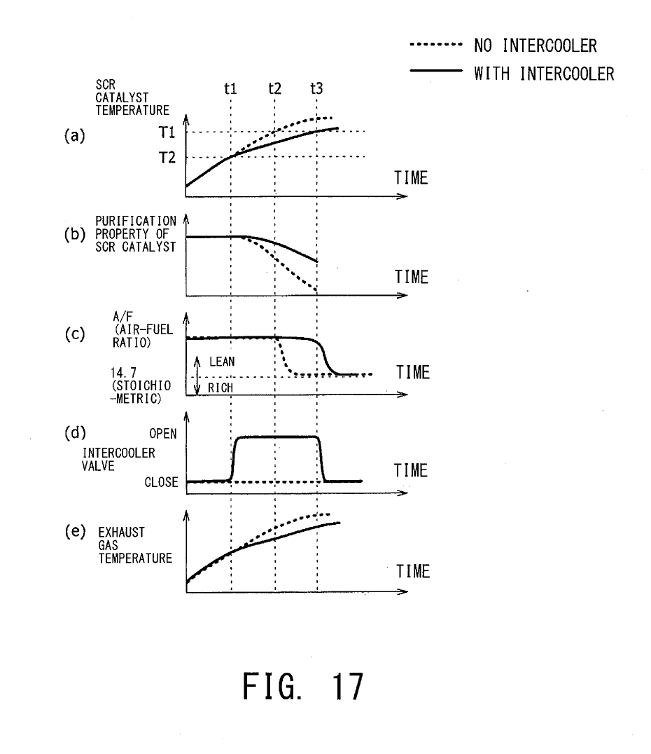

FIG. 16 is a flowchart showing processing performed in the combustion switching controller 11 of the internal combustion engine 10C illustrated in FIG. 14. In the processing, process steps identical to those of the processing in the internal combustion engine 10B of the above-described third embodiment (see FIG. 10) are identified by the same reference numerals as those of the third embodiment, and as appropriate descriptions related to the process steps are not repeated.

As shown in FIG. 16, the combustion switching controller 11 initially acquires the NOx reduction catalyst temperature T in Step 20. For the NOx reduction catalyst temperature T, the value acquired by the temperature sensor 41 and stored in the memory unit may be used. Note that processing in Step 20 is identical to that performed in the internal combustion engine 10 or 10A in the first or second embodiment.

Subsequently, the combustion switching controller 11 performs processing in Steps 22 to 27. In this processing, when the temperature T of the NOx reduction catalyst 40 is greater than or equal to the predetermined value T1, the operation state of the engine 12 is switched from the normal lean combustion mode to the stoichiometric combustion mode, which is identical to the processing shown in FIG. 2 of the first embodiment and the processing shown in FIG. 10 of the third embodiment. Accordingly, the same effect as that in the first and third embodiments can be obtained in the fourth embodiment.

On the other hand, when a negative determination is obtained in Step 24; i.e., when the temperature T of the NOx reduction catalyst 40 is lower than the predetermined value T1, the combustion switching controller 11 determines, in Step 30, whether or not the temperature T of the NOx reduction catalyst 40 is greater than or equal to the predetermined value T2 (where T2<T1). When an affirmative determination (YES) is obtained in Step 30, operation moves to Step 41, whereas when a negative determination (NO) is obtained in Step 30, operation moves to Step 40.

In the case of the negative determination in above-described Step 30; i.e., when the temperature T of the NOx reduction catalyst 40 is lower than the predetermined value T2, the combustion switching controller 11 controls the opening of the intercooler valve 83 in Step 40 using a map on which the engine rotation speed Ne and the fuel injection quantity Q are plotted as coordinates on two axes. In other words, the opening of the intercooler valve 83 is determined based on the load condition of the engine 12 in the above case. Then, in subsequent Step 35, the combustion switching controller 11 determines the use of the map for the normal lean combustion. Following this, in Steps 26 and 27, the combustion switching controller 11 determines the control parameters from the engine rotation speed Ne and the fuel injection quantity Q based on the determined map, and performs control operation using the determined control parameters. In other words, the combustion switching controller 11 controls the engine 12 to be operated in the normal lean combustion mode. Note that the processing in Step 35 and Steps 26 and 27 is the same as that in the internal combustion engine 10C of the third embodiment explained with reference to FIG. 10.

On the other hand, in the case of the affirmative determination in above-described Step 30; i.e., when the temperature T of the NOx reduction catalyst 40 is greater than or equal to the predetermined value T2, the combustion switching controller 11 determines, in Step 41, whether or not the intercooler valve 83 is fully opened. Here, when the intercooler valve 83 is determined to be fully opened (YES in Step 41), because the opening of the intercooler valve 83 cannot be opened further (i.e., the cooling power cannot be enhanced), the combustion switching controller 11 immediately performs processing in Step 35 and Steps 26 and 27 to implement the normal lean combustion mode.

As opposed to the above, when the intercooler valve 83 is not determined to be fully opened (NO in Step 41), the combustion switching controller 11 causes the intercooler valve 83 to be further opened, and subsequently performs processing in Step 35 and Steps 26 and 27. In this way, the cooling power of the intercooler 84 is enhanced to thereby lower the temperature of air introduced into the engine 12. As a result of this, the exhaust gas temperature to be obtained in the normal lean combustion mode by performing the processing in Step 35 and Steps 26 and 27 can be lowered, to thereby reduce the quantity of generation of NOx contained in the exhaust gas. The generation of NOx can be minimized by performing a control mode for lowering the exhaust gas temperature using the intercooler 84 as described above.

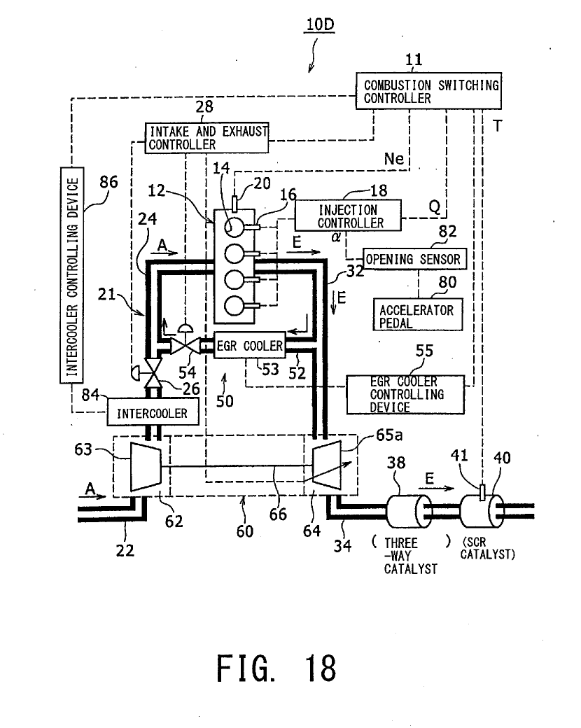

In FIG. 17, graphs respectively represent (a) the temperature of the NOx reduction (SCR) catalyst, (b) the purification property of the SCR catalyst, (c) the air-fuel ratio, (d) action of the intercooler valve, and (e) the exhaust gas temperature. Here, in each of the graphs (a) to (e), time is plotted on the abscissa on which time t1 is a point in time at which the SCR catalyst temperature exceeds the predetermined value T2, time t2 is a point in time at which the combustion mode is switched to the stoichiometric combustion mode not accompanied with the exhaust gas lowering mode, and time t3 is a point in time at which the combustion mode is switched to the stoichiometric combustion mode accompanied with the exhaust gas temperature lowering mode. Further, in each of the graphs (a) to (e) of FIG. 17, the broken lines represent a case where the intercooler 84 is not installed, while the solid lines represents a case where the exhaust gas temperature lowering mode is performed using the intercooler 84.

As shown in graphs (a) to (e) in FIG. 17, in the internal combustion engine 10C of the fourth embodiment, when the temperature of the NOx reduction catalyst 40 reaches or exceeds the predetermined value T2, the exhaust gas temperature lowering mode is implemented after increasing the opening of the intercooler valve 83 unless the intercooler valve 83 is fully opened. In this way, the temperature of intake air supplied to the engine 12 is lowered, and the exhaust gas temperature is accordingly lowered, which can, in turn, curb a rise in temperature of the NOx reduction catalyst 40. More specifically, if the exhaust gas temperature lowering mode is not used, the temperature of the NOx reduction catalyst 40 reaches or exceeds the predetermined value T1 at time t2, resulting in switching from the normal lean combustion mode to the stoichiometric combustion mode. As opposed to this, the use of the exhaust gas temperature lowering mode in the internal combustion engine 10C of the fourth embodiment causes the rise in temperature of the NOx reduction catalyst 40 to be slowed down, so that the point in time at which the temperature reaches or exceeds the predetermined value T1 can be delayed to time t3. As a result of this delay, the timing of transition to the stoichiometric mode can be delayed, to thereby improve fuel efficiency while preventing an increase in the quantity of NOx emissions.

It should be noted that while the fourth embodiment has been described with reference to the example in which the intercooler 84 is used to perform the control mode of lowering the exhaust gas temperature, the exhaust gas return quantity regulating valve 54 (the exhaust gas return quantity regulating device), the variable nozzle vane of the turbocharger 60 (the supercharging pressure regulating device), and the intake throttle valve 26 (the air quantity regulator) may be simultaneously controlled in addition to controlling the cooling power of the intercooler 84, so as to increase the supercharging pressure and adjust the air-fuel ratio and the EGR rate.

### Fifth Embodiment

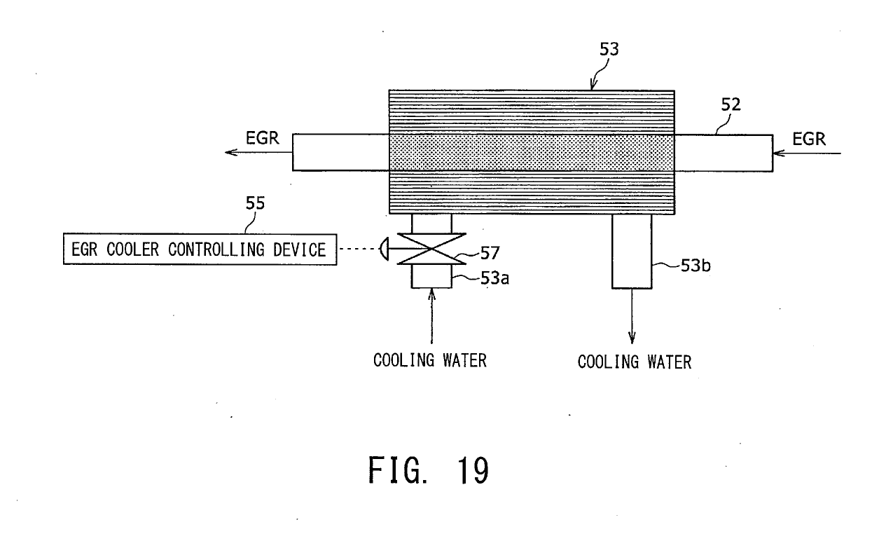

Next, referring to FIGS. 18 to 21, an internal combustion engine 10D according to a fifth embodiment will be described. FIG. 18 schematically shows an overall configuration of the internal combustion engine 10D in the fifth embodiment. FIG. 19 shows an EGR cooler 53 illustrated in FIG. 18. In the following description, the internal combustion engine 10D in the fifth embodiment is explained, focusing on its configuration different from that in the fourth embodiment. The same components as those of the internal combustion engines 10, 10A, 10B, and 10C according to the first to fourth embodiments are designated by the same reference numerals as those of the first to fourth embodiments, and as appropriate the descriptions related to the components will not be repeated.

The internal combustion engine 10D of the fifth embodiment includes the EGR cooler (recirculated exhaust gas cooler) 53. The EGR cooler 53 has a function of cooling the exhaust gas recirculated into the engine 12 by the exhaust gas returning device 50. The EGR cooler 53 is disposed upstream of the exhaust gas return quantity regulating valve 54 along a flow direction of the exhaust gas in the exhaust gas return passage 52.

As shown in FIG. 19, a cooling device of a water cooling type is preferably used for the EGR cooler 53. The EGR cooler 53 has a feed pipe 53a and a discharge pipe 53b for cooling water, and the feed pipe 53a is equipped with an EGR cooler valve 57 for regulating the quantity of cooling water. The opening of the EGR cooler valve 57 is regulated in response to a command from an EGR cooler controlling device 55. In this way, the EGR cooler 53 is configured to have a variable EGR gas cooling power which can be changed by regulating the quantity of cooling power to be supplied.

Referring again to FIG. 18, the EGR cooler controlling device 55 is electrically connected to the combustion switching controller 11. The combustion switching controller 11 can regulate the opening of the EGR cooler valve 57 via the EGR cooler controlling device 55, to thereby control the cooling power of the EGR cooler 53.

It should be noted that the cooling power of the EGR cooler 53 may be changed by changing the temperature of cooling water. Further, the EGR cooler 53 is not limited to that of the water cooling type, and may be of an air cooling type. In the case of the air cooling type, the cooling power of the EGR cooler 53 can be changed by changing the quantity of cooling air.

The components of the internal combustion engine 10D in the fifth embodiment other than those described above are the same as those of the internal combustion engine 10C in the fourth embodiment.

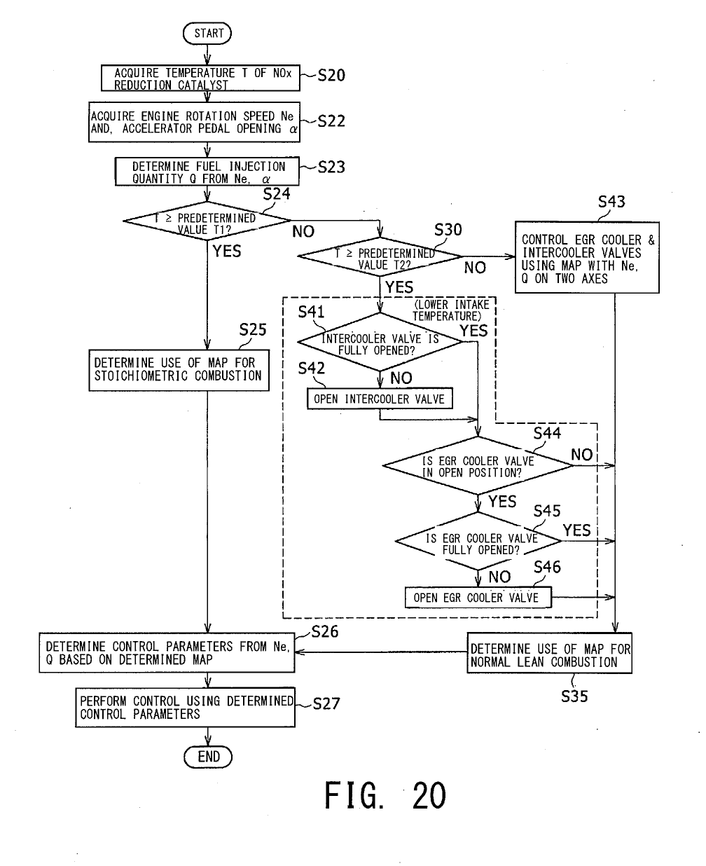

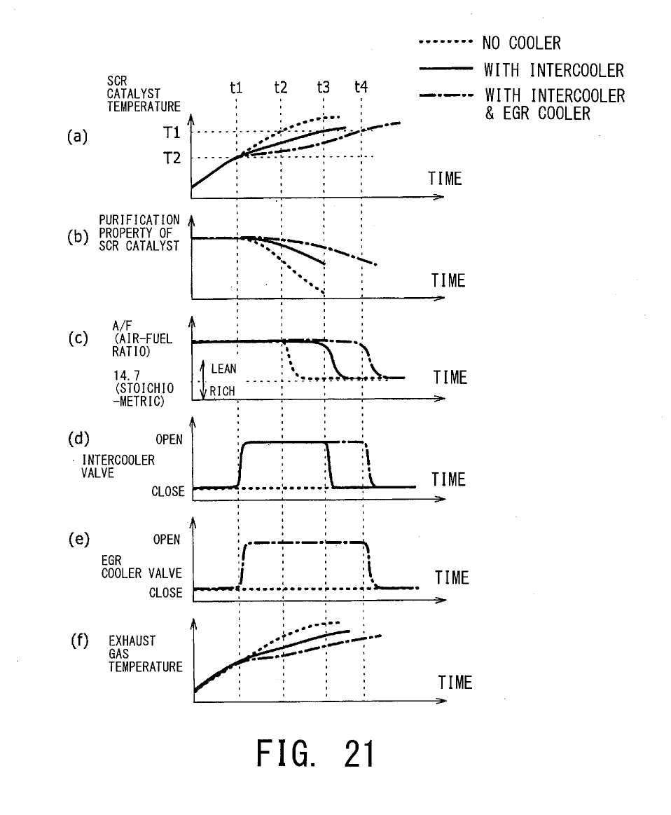

FIG. 20 is a flowchart showing processing performed in the combustion switching controller 11 of the internal combustion engine 10D illustrated in FIG. 18. In the processing, process steps identical to those in the processing in the above-described internal combustion engine 10C of the fourth embodiment (see FIG. 16) are identified by the same reference numerals as those of the fourth embodiment, and as appropriate descriptions related to the process steps are not repeated. In the processing shown in FIG. 20, processing in Steps 43 to 46 related to the EGR cooler 53 is different from that shown in FIG. 16, and processing other than Steps 43 to 46 are the same as that shown in FIG. 16.

As shown in FIG. 20, the combustion switching controller 11 determines, in Step 30, whether or not the temperature T of the NOx reduction catalyst 40 is greater than or equal to the predetermined value T2 (where T2<T1). When an affirmative determination (YES) is obtained in Step 30, operation moves to Step 41, and when a negative determination (NO) is obtained in Step 30, operation moves to Step 43.

In the case of the negative determination in above-described Step 30; i.e., when the temperature T of the NOx reduction catalyst 40 is lower than the predetermined value T2, the combustion switching controller 11 controls, in Step 43, the opening of the EGR cooler valve 57 and the opening of the intercooler valve 83 using a map for the EGR cooler and a map for the intercooler, respectively, the maps on which the engine rotation speed Ne and the fuel injection quantity Q are plotted as coordinates on two axes. That is, in this case, the openings of the EGR cooler valve 57 and the intercooler valve 83 are determined based on the load condition of the engine 12. Then, the combustion switching controller 11 determines, in subsequent Step 35, the use of the map for the normal lean combustion. Subsequently, in Steps 26 and 27, the combustion switching controller 11 determines the control parameters from the engine rotation speed Ne and the fuel injection quantity Q based on the determined map, and performs control operation using the determined control parameters. In other words, the combustion switching controller 11 controls the engine 12 to be operated in the normal lean combustion mode.

On the other hand, in the case of the affirmative determination in above-described Step 30; i.e., when the temperature T of the NOx reduction catalyst 40 is greater than or equal to the predetermined value T2, the combustion switching controller 11 controls, in Steps 41 and 42, the opening of the inter cooler valve 83. This control is identical to the processing in FIG. 16 of the fourth embodiment.

The combustion switching controller 11 determines, in Step 44 following the processing in Step 42, whether or not the EGR cooler valve 57 is in an open position. Here, when a negative determination (NO) is obtained, the combustion switching controller 11 performs processing in Step 35 and Steps 26 and 27 to implement the normal lean combustion mode. On the other hand, when the EGR cooler valve 57 is determined to be in the open position (YES in Step 44), the combustion switching controller 11 determines, in Step 45, whether or not the EGR cooler valve 57 is fully opened. Here, when the EGR cooler valve 57 is determined to be fully opened (YES in Step 45), because the opening of the EGR cooler valve 57 cannot be further increased (i.e., the cooling power cannot be enhanced), the combustion switching controller 11 immediately performs processing in Step 35 and Steps 26 and 27 to implement the normal lean combustion mode.

As opposed to this, when the EGR cooler valve 57 is not determined to be fully opened (NO in Step 45), the combustion switching controller 11 causes, in Step 46, the EGR cooler valve 57 to be further opened, and subsequently performs processing in Step 35 and Steps 26 and 27. In this way, the cooling power of the EGR cooler 53 is enhanced, so that the temperature of the exhaust gas to be recirculated into the engine 12 is lowered, and thus the intake air temperature is lowered. As a result of this, the exhaust gas temperature to be obtained in the normal lean combustion mode implemented through the processing in Step 35 and Steps 26 and 27 can be lowered, to thereby reduce the quantity of generation of NOx contained in the exhaust gas. Thus, generation of NOx can be further minimized by performing the control mode of lowering the exhaust gas temperature using the EGR cooler 53.

In FIG. 21, graphs respectively represent (a) the temperature of the NOx reduction (SCR) catalyst, (b) the purification property of the SCR catalyst, (c) the air-fuel ratio, (d) action of the EGR cooler valve, (e) action of the EGR cooler valve, and (f) the exhaust gas temperature. Here, in each of the graphs (a) to (f), time is plotted on the abscissa on which time t1 is a point in time at which the SCR catalyst temperature exceeds the predetermined value T2, time t2 is a point in time at which the combustion mode is switched to the stoichiometric combustion mode which is not accompanied with the exhaust gas lowering mode using the EGR cooler 53 and the intercooler 84, time t3 is a point in time at which the combustion mode is switched to the stoichiometric combustion mode accompanied with the exhaust gas temperature lowering mode using the intercooler 84, and time t4 is a point in time at which the combustion mode is switched to the stoichiometric combustion mode accompanied with the exhaust gas temperature lowering mode using both the EGR cooler 53 and the intercooler 84.

Further, in each of the graphs (a) to (f) in FIG. 21, the broken lines represent a case where neither of the EGR cooler 53 and the intercooler 84 is installed or where the exhaust gas temperature lowering mode using the coolers 53 and 84 is not performed, the solid lines represents a case where the exhaust gas temperature lowering mode is performed using the intercooler 84, and the dot-and-dash lines represent a case where the exhaust gas lowering mode is performed using both the EGR cooler 53 and the intercooler 84.

In each of the graphs (a) to (d) and graph (f) in FIG. 21, the broken and solid lines are the same as those shown on graphs (a) to (e) of FIG. 17. That is, in the internal combustion engine 10D of the fifth embodiment, when the temperature T of the NOx reduction catalyst 40 reaches or exceeds the predetermined value T2, the exhaust gas temperature lowering mode is implemented after the opening of the intercooler valve 83 is increased unless the intercooler valve 83 is fully opened. This lowers the temperature of intake air supplied to the engine 12, and accordingly lowers the exhaust gas temperature, which can, in turn, contribute to a retarded increase in temperature of the NOx reduction catalyst 40.

Further, in the internal combustion engine 10D of the fifth embodiment, the exhaust gas temperature lowering mode is additionally implemented using the EGR cooler 53 for cooling the exhaust gas to be recirculated into the engine 12. Specifically, as shown in graphs (d) and (e) in FIG. 21, both of the intercooler valve 83 and the EGR cooler valve 57 are opened to lower the temperatures of the intake air and recirculated exhaust gas. In this way, as shown in the graph (f) in FIG. 21, the rise of the exhaust gas temperature can be further slowed as compared with the case of solely using the intercooler 84. As a result of this, the point in time at which the temperature T of the NOx reduction catalyst 40 reaches or exceeds the predetermined value T1 can be further delayed to the time t4. Thus, according to the internal combustion engine 10D in the fifth embodiment, the timing of transition to the stoichiometric combustion mode can be further delayed as compared with the case of the internal combustion engine 10C of the fourth embodiment, which can further enhance fuel efficiency while preventing an increase in the quantity of NOx emissions.

It should be noted that although in the fifth embodiment the example of performing the control mode to lower the exhaust gas temperature using both the EGR cooler 53 and the intercooler 84 has been described, the control mode may be performed only using the EGR cooler 53 to lower the exhaust gas temperature. In this case, in addition to controlling the cooling power of the EGR cooler 53, the exhaust gas return quantity regulating valve 54 (exhaust gas return quantity regulating device), the variable nozzle vane of the turbocharger 60 (the supercharging pressure regulating device), and the intake throttle valve 26 (the air quantity regulating valve) may be simultaneously controlled to adjust the air-fuel ratio and the EGR ratio while increasing the supercharging pressure. It should be noted that the internal combustion engine according to this invention is not limited to the above-described embodiments or its modification examples, and may be altered or changed in various ways within the scope of matters defined in the accompanying claims of this application and within the scope of equivalents of such matters.

For example, although the example of using the turbocharger 60 as the supercharger has been described above, this invention is not limited to the example. A mechanical supercharger which performs supercharging operation by means of engine power may be used in place of the turbocharger 60 of the first to fifth embodiments. Still further, the turbocharger, the mechanical supercharger, or a combination thereof may be installed as the supercharger in a plurality of stages. Moreover, in addition to the turbocharger, the mechanical supercharger, and the electrically operated compressor, a pressure accumulating tank for storing compressed air may be installed, and compressed air supplied from the pressure accumulating tank may be used for supercharging. In the case where supercharging operation is performed using the pressure accumulating tank in the third embodiment, when a remaining quantity of compressed air in the pressure accumulating tank is lower than or equal to a predetermined value, it may be determined that transition to the exhaust gas temperature lowering mode is not performed (NO) in Step 33.

In addition, although the example of using the variable nozzle vane as the supercharging pressure regulating device has been described in the second to fifth embodiments, a waste gate valve controlled in a manner similar to that in the first embodiment may be used in place of the variable nozzle vane.

Further, although the electrically operated compressor 70 is configured to assist supercharging operation of the turbocharger 60 in the second and third embodiments, assisting the super charging operation is not limited to such a configuration. For example, the pressure accumulating tank may be installed, and compressed air supplied from the pressure accumulating tank may be introduced into a site downstream of the intake throttle valve 26 in the intake direction or upstream of the turbine 65a in the exhaust direction, to thereby assist supercharging operation.

Still further, although the example of using the exhaust gas bypass channel 34b to lower the temperature T of the NOx reduction catalyst 40 has been described in the second embodiment, this invention is not limited to the example, and a temperature controller for adjusting the exhaust gas temperature may be installed between the three-way catalyst and the NOx reduction catalyst. Alternatively, external air may be directly supplied into the exhaust system to retard an increase in temperature of the NOx reduction catalyst or to lower the temperature, or a cooling device to cool the NOx reduction catalyst may be installed.

Moreover, when the NOx reduction catalyst is implemented by the SCR catalyst in the first to fifth embodiments, it is preferable that a device for adding a reducer (such as, for example, urea) is arranged on an upstream side of the SCR catalyst in the exhaust system 30.

### REFERENCE SIGNS LIST

10, 10A internal combustion engine; 11 combustion switching controller; 12 engine; 14 cylinder; 16 fuel injection device; 18 injection controller; 20 rotation speed sensor (rotation speed acquiring unit); 21 intake system; 22 first intake gas passage; 24 second intake gas passage; 26 intake throttle valve; 28 intake and exhaust controller; 30 exhaust system; 32 first exhaust gas passage; 34 second exhaust gas passage; 34a main exhaust gas channel; 34b exhaust gas bypass channel; 36 turbine bypass channel; 38 three-way catalyst; 40 NOx reduction catalyst; 41 temperature sensor (temperature acquiring unit); 42 waste gate valve (supercharging pressure regulating device); 50 exhaust gas returning device; 52 exhaust gas return passage; 53 EGR cooler (recirculated exhaust gas cooler); 54 exhaust gas return quantity regulating valve (exhaust gas return quantity regulating device); 55 EGR cooler controlling device; 57 EGR cooler valve; 60 turbocharger (supercharger); 62 compressor chamber; 63, 72 compressor wheel; 64 turbine chamber; 65 turbine; 65a turbine with variable nozzle vane; 66 shaft; 70 electrically operated compressor (supercharger); 74 motor (supercharging pressure regulating device); 76 electrically operated supercharger controlling device; 78 electric line; 80 accelerator pedal; 82 opening sensor; 83 intercooler valve; 84 intercooler; 86 intercooler controlling device; A intake direction; B battery; E exhaust gas discharge direction; Ne engine rotation speed; Q fuel injection quantity; T temperature or NOx reduction catalyst temperature; V1 first switching valve (channel switching device); V2 second switching valve (channel switching device).

1. An internal combustion engine, comprising:
an engine;
a three-way catalyst and a NOx reduction catalyst that purify exhaust gas emitted from the engine;
a temperature acquiring unit that acquires a temperature of the NOx reduction catalyst;
a rotation speed acquiring unit that acquires an engine rotation speed;
an injection controller that controls a fuel injection quantity in the engine; and
a combustion switching controller that switches a combustion mode of the engine between a lean combustion mode and a stoichiometric combustion mode based on the temperature of the NOx reduction catalyst acquired by the temperature acquiring unit, the engine rotation speed acquired by the rotation speed acquiring unit, and the fuel injection quantity acquired from the injection controller.

2. The internal combustion engine according to claim 1, wherein the combustion switching controller switches the lean combustion mode to the stoichiometric combustion mode when the temperature of the NOx reduction catalyst is greater than or equal to a predetermined value in the lean combustion mode.

3. The internal combustion engine according to claim 1, wherein the combustion switching controller maintains the stoichiometric combustion mode when the temperature of the NOx reduction catalyst is greater than or equal to a predetermined value in the stoichiometric combustion mode.

4. The internal combustion engine according to claim 1, wherein the combustion switching controller controls an intake state of the engine in such a manner that an air-fuel ratio becomes equal to a stoichiometric ratio in the stoichiometric combustion mode.

5. The internal combustion engine according to claim 1, wherein the temperature acquiring unit detects or predicts the temperature of the NOx reduction catalyst.

6. The internal combustion engine according to claim 1, wherein the NOx reduction catalyst is composed of either or both of a selective reduction catalyst (SCR catalyst) and a storage reduction catalyst (NSR catalyst).

7. The internal combustion engine according to claim 1, wherein the NOx reduction catalyst is disposed downstream of the three-way catalyst in an exhaust gas discharge direction.

8. The internal combustion engine according to claim 1, further comprising:
an exhaust gas returning device that recirculates a part of the exhaust gas discharged from the engine;
an exhaust gas return quantity regulating device that regulates a quantity of the exhaust gas to be recirculated into the engine;
a supercharger that supercharges air to be introduced into the engine;
a supercharging pressure regulating device that regulates a supercharging pressure exerted by the supercharger; and
an air quantity regulating device that regulates a quantity of air to be introduced.

9. The internal combustion engine according to claim 8, wherein the supercharger is composed of at least one of a turbocharger, a mechanical supercharger, and an electrically operated compressor.

10. The internal combustion engine according to claim 8, wherein the supercharging pressure regulating device is composed of a waste gate valve disposed in a turbine bypass channel, a variable nozzle vane for changing a flow velocity of the exhaust gas impinging onto a turbine, or a motor for an electrically operated compressor.

11. The internal combustion engine according to claim 8, wherein the combustion switching controller controls the exhaust gas return quantity regulating device and the air quantity regulating device to establish, in a stoichiometric combustion mode, an intake oxygen concentration and a supercharging pressure which are predetermined for an engine operation condition, to thereby perform predetermined fuel injection control corresponding to the engine operation condition.

12. The internal combustion engine according to claim 8, wherein the combustion switching controller controls the exhaust gas return quantity regulating device, the air quantity regulating device, and the supercharging pressure regulating device to establish, in a stoichiometric combustion mode, an intake oxygen concentration and a supercharging pressure which are predetermined for an engine operation condition, to thereby perform predetermined fuel injection control corresponding to the engine operation condition.

13. The internal combustion engine according to claim 8, wherein the combustion switching controller determines whether or not the engine rotation speed and the fuel injection quantity are contained in a stoichiometric combustion region, and controls operation to perform high supercharging lean combustion with a supercharging pressure increased by the supercharging pressure regulating device when the engine rotation speed and the fuel injection quantity are determined to be out of the stoichiometric combustion region at the temperature of the NOx reduction catalyst greater than or equal to a predetermined value.

14. The internal combustion engine according to claim 8, further comprising a channel switching device configured to allow selective switching between an exhaust gas bypass channel, which is branched from an exhaust passage between the three-way catalyst and the NOx reduction catalyst and merged into the exhaust passage downstream of the NOx reduction catalyst, and a channel through which the exhaust gas is directed to pass through the NOx reduction catalyst.

15. The internal combustion engine according to claim 14, wherein the channel switching device is operated by the combustion switching controller for causing the exhaust gas to pass through both the three-way catalyst and the NOx reduction catalyst in the lean combustion mode in a normal state.

16. The internal combustion engine according to claim 15, wherein the channel switching device is operated by the combustion switching controller for decreasing a quantity of exhaust gas that passes through the NOx reduction catalyst while increasing a quantity of exhaust gas that passes through the exhaust gas bypass channel in the stoichiometric combustion mode.

17. The internal combustion engine according to claim 16, wherein the channel switching device is operated by the combustion switching controller for regulating the quantity of exhaust gas that passes through the NOx reduction catalyst and the exhaust gas bypass channel depending on the temperature of the NOx reduction catalyst.

18. The internal combustion engine according to claim 8, wherein:
the supercharger comprises a main supercharger and an auxiliary supercharger, the main supercharger being composed of either or both of a turbocharger and a mechanical supercharger, and the auxiliary supercharger being composed of either or both of an electrically operated compressor and a pressure accumulating tank;
the internal combustion engine further comprises, as a supercharging pressure regulating device for the auxiliary supercharger, a motor for the electrically operated compressor and a valve for the pressure accumulating tank; and
when the temperature of the NOx reduction catalyst is lower than a predetermined value T1 and greater than or equal to a predetermined value T2 (where T2<T1), the combustion switching controller causes transition to a control mode for lowering an exhaust gas temperature, the control mode in which the supercharging pressure regulating device for the auxiliary supercharger is used to increase the supercharging pressure, to thereby lower the exhaust gas temperature.

19. The internal combustion engine according to claim 18, wherein in addition to controlling the supercharging pressure regulating device for the auxiliary supercharger, the combustion switching controller simultaneously controls, in the control mode for lowering the exhaust gas temperature, the exhaust gas return quantity regulating device, the air quantity regulating device, and the supercharging pressure regulating device for the main supercharger based on the operation condition, to adjust both an air-fuel ratio and an EGR ratio simultaneously while increasing the supercharging pressure.

20. The internal combustion engine according to claim 18, wherein the combustion switching controller does not cause the transition to the control mode for lowering the exhaust gas temperature even when the temperature of the NOx reduction catalyst is lower than the predetermined value T1 and greater than or equal to the predetermined value T2 as long as either or both of a remaining power of a battery for driving the motor of the electrically operated compressor and a remaining quantity of compressed air in the pressure accumulating tank are smaller than or equal to a predetermined value.

21. The internal combustion engine according to claim 18, wherein when a predetermined condition is satisfied in a state where the engine is operated in the stoichiometric combustion mode, the combustion switching controller causes transition to an EGR stoichiometric combustion mode for lowering the exhaust gas temperature, the EGR stoichiometric combustion mode in which the supercharging pressure regulating device for the auxiliary supercharger and the exhaust gas return quantity regulating device are used to increase a return quantity of exhaust gas without changing an introduction quantity of intake gas, to thereby lower the exhaust gas temperature.

22. The internal combustion engine according to claim 21, wherein, in the state where the engine is operated in the stoichiometric combustion mode, the combustion switching controller estimates, based on the engine rotation speed and a torque, a temperature of the NOx reduction catalyst that is expected to be obtained by switching to the EGR stoichiometric combustion mode, and switches to the EGR stoichiometric combustion mode when the estimated temperature is lower than the predetermined value T1.

23. The internal combustion engine according to claim 8, further comprising an intercooler that is disposed downstream of the supercharger in an intake direction to cool intake air, and configured to have a variable intake air cooling power.

24. The internal combustion engine according to claim 23, wherein the combustion switching controller performs a control mode for lowering an exhaust gas temperature when the temperature of the NOx reduction catalyst is lower than a predetermined value T1 and greater than or equal to a predetermined value T2 (where T2<T1), the control mode in which the cooling power of the intercooler is enhanced to lower an intake air temperature and accordingly lower the exhaust gas temperature.

25. The internal combustion engine according to claim 23, wherein, in addition to controlling the cooling power of the intercooler, the combustion switching controller simultaneously controls the exhaust gas return quantity regulating device, the supercharging pressure regulating device, and the air quantity regulating device, to adjust the air-fuel ratio and the EGR ratio while increasing the supercharging pressure.

26. The internal combustion engine according to claim 8, wherein the exhaust gas returning device comprises a recirculated exhaust gas cooler for cooling the exhaust gas to be recirculated, and the recirculated exhaust gas cooler is configured to have a variable exhaust gas cooling power.

27. The internal combustion engine according to claim 26, wherein the combustion switching controller performs a control mode for lowering the exhaust gas temperature when the temperature of the NOx reduction catalyst is lower than a predetermined value T1 and greater than or equal to a predetermined value T2 (where T2<T1), the control mode in which the cooling power of the recirculated exhaust gas cooler is enhanced to thereby lower an intake air temperature and accordingly lower the exhaust gas temperature.

28. The internal combustion engine according to claim 26, wherein in addition to controlling the cooling power of the recirculated exhaust gas cooler, the combustion switching controller simultaneously controls the exhaust gas return quantity regulating device, the supercharging pressure regulating device, and the air quantity regulating device, to adjust the air-fuel ratio and the EGR ratio while increasing the supercharging pressure.

29. The internal combustion engine according to claim 8, further comprising:
an intercooler that is disposed downstream of the supercharger in an intake direction to cool intake air, and configured to have a variable intake air cooling power, wherein
the exhaust gas returning device comprises a recirculated exhaust gas cooler that is configured to cool the exhaust gas to be recirculated, and to have a variable exhaust gas cooling power, and
the combustion switching controller performs a control mode for lowering the exhaust gas temperature, the control mode in which the cooling powers of the intercooler and the recirculated exhaust gas cooler are controlled to lower the exhaust gas temperature.

30. The internal combustion engine according to claim 29, wherein in addition to controlling the cooling powers of the intercooler and the recirculated exhaust gas cooler, the combustion switching controller simultaneously controls the exhaust gas return quantity regulating device, the supercharging pressure regulating device, and the air quantity regulating device, to adjust the air-fuel ratio and the EGR ratio while increasing the supercharging pressure.
